(19) United States
(12) Patent Application Publication
(10) Pub. No.: US 2026/0320954 A1
(43) Pub. Date: Oct. 15, 2026

(54) CONTROL ADJUSTMENT METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Shayuan XU, Shenzhen (CN)

(21) Appl. No.: 19/694,518

(22) Filed: Jun. 1, 2026

Related U.S. Application Data
(63) Continuation of application No. PCT/CN2025/070861, filed on Jan. 6, 2025.

(30) Foreign Application Priority Data
Feb. 2, 2024 (CN) 202410160435.6

(51) Int. Cl. G06T 19/20; G06F 3/04815; G06F 3/04847

(52) U.S. Cl. CPC G06T 19/20; G06F 3/04815; G06F 3/04847; G06T 2219/2004

(57) ABSTRACT

A control adjustment method includes the following operations: displaying an element region and an element level adjustment region ; detecting a slide operation performed on a first adjustment control; and displaying an adjusted first adjustment control based on a first slide vector component and a second slide vector component, and displaying, based on a level of the adjusted first adjustment control in the element level adjustment region, a first virtual element subjected to level adjustment in the element region.

### CROSS-REFERENCES TO RELATED APPLICATIONS

This application is a continuation of PCT Application No. PCT/CN2025/070861, filed on Jan. 6, 2025, which claims priority to Chinese Patent Application No. 202410160435.6, entitled “CONTROL ADJUSTMENT METHOD AND APPARATUS, DEVICE, MEDIUM, AND PROGRAM PRODUCT” and filed on Feb. 2, 2024, the entire contents of all of which are incorporated herein by reference.

### FIELD OF THE TECHNOLOGY

The present disclosure relates to the field of computer technologies, and in particular, to a control adjustment method and apparatus, a device, a medium, and a program product.

### BACKGROUND OF THE DISCLOSURE

Some application programs providing an interface editing capability allow users to customize styles and functions of various controls on a display region via a layer management region, and adjust positions of the controls, to meet creation requirements of the users.

Arranging controls in different layers can enrich content levels of the display region. When a user drags the controls up and down in the layer management region and adjusts a sequence of the controls in the layer management region, a corresponding display effect is displayed in the display region. For example, the display region includes a first control (corresponding to text content) and a second control (corresponding to picture content). When the first control is placed in a layer above the second control via the layer management region, the text content is displayed above the picture content in the display region.

However, when there are a large number of controls, the user needs to frequently expand or collapse the control list in order to drag a selected control to a selected layer, or the user needs to drag a control to move for a long distance in order to reach a selected layer. This process results in the user spending a large amount of time adjusting the controls to corresponding layers, leading to inefficient human-computer interaction.

### SUMMARY

Embodiments of the present disclosure provide a control adjustment method and apparatus, a device, a medium, and a program product, to improve efficiency of control adjustment. Technical solutions are as follow:

According to an aspect, a control adjustment method is provided, performed by a computer device. The method includes: displaying an element region including at least two virtual elements, and displaying an element level adjustment region including at least two adjustment controls arranged in a first direction, the at least two adjustment controls including a first adjustment control, and the first adjustment control being configured to adjust a first virtual element among the at least two virtual elements; detecting a slide operation performed on the first adjustment control, the slide operation including a first slide vector component in the first direction and a second slide vector component in a second direction, the first direction being different from the second direction; and displaying an adjusted first adjustment control based on the first slide vector component and the second slide vector component, and displaying, based on a level of the adjusted first adjustment control in the element level adjustment region, the first virtual element subjected to level adjustment in the element region.

According to another aspect, a computer device is provided. The computer device includes a processor and a memory, the memory having at least one instruction, at least one program, a code set, or an instruction set stored therein, the at least one instruction, the at least one program, the code set, or the instruction set being loaded and executed by the processor to implement the control adjustment method according to any one of the foregoing embodiments of the present disclosure.

According to another aspect, a non-transitory computer-readable storage medium is provided, having at least one instruction, at least one program, a code set, or an instruction set stored therein, the at least one instruction, the at least one program, the code set, or the instruction set being loaded and executed by a processor to implement the control adjustment method according to any one of the foregoing embodiments of the present disclosure.

The technical solutions provided in the embodiments of the present disclosure produce at least the following beneficial effects.

An element region and a corresponding element level adjustment region are displayed. A corresponding virtual element in the display element region can be synchronously adjusted by adjusting at least two adjustment controls arranged in a first direction in the element level adjustment region, thereby adjusting a level of the virtual element in the element region. A slide operation performed on the adjustment control is received, and a position of the adjustment control is adjusted based on the slide operation. The slide operation corresponds to a slide vector component separately in the first direction and a second direction, so that the control can be accurately adjusted in at least two directions. When a quantity of adjustment controls in the element level adjustment region is relatively large, it is unnecessary to frequently collapse or expand a control list and then adjust controls. Adjustment is implemented based on slide vector components of a same slide operation in different directions, so that an adjustment process is more convenient, and efficiency of human-computer interaction is improved.

### BRIEF DESCRIPTION OF THE DRAWINGS

FIG. 1 is a schematic diagram of adjusting a level of a virtual control according to an exemplary embodiment of the present disclosure.

FIG. 2 is a schematic flowchart of a method for adjusting a control according to an exemplary embodiment of the present disclosure.

FIG. 3 is a schematic diagram of a process of adjusting a component level based on slide vector components in different directions according to an exemplary embodiment of the present disclosure.

FIG. 4 is a structural block diagram of an electronic device according to an exemplary embodiment of the present disclosure.

FIG. 5 is a structural block diagram of a computer system according to an exemplary embodiment of the present disclosure.

FIG. 6 is a flowchart of a control adjustment method according to an exemplary embodiment of the present disclosure.

FIG. 7 is a schematic diagram of an element region and an element level adjustment region according to an exemplary embodiment of the present disclosure.

FIG. 8 is a schematic diagram of two manners of determining a slide vector component according to an exemplary embodiment of the present disclosure.

FIG. 9 is a schematic diagram of displaying a dividing line feature based on a second slide vector component according to an exemplary embodiment of the present disclosure.

FIG. 10 is a schematic diagram of a process of displaying an adjusted first adjustment control based on a first slide vector component and a second slide vector component according to an exemplary embodiment of the present disclosure.

FIG. 11 is a schematic diagram of a manner of performing level adjustment on an adjustment control based on a first slide vector component according to an exemplary embodiment of the present disclosure.

FIG. 12 is a schematic diagram of expanding a component adjustment control by a group adjustment control according to an exemplary embodiment of the present disclosure.

FIG. 13 is a schematic diagram of collapsing a component adjustment control by a group adjustment control according to an exemplary embodiment of the present disclosure.

FIG. 14 is a schematic diagram of a process in which a terminal determines a control adjustment type according to an exemplary embodiment of the present disclosure.

FIG. 15 is a flowchart of a control adjustment method according to another exemplary embodiment of the present disclosure.

FIG. 16 is a flowchart of a method for performing level adjustment on a group adjustment control according to an exemplary embodiment of the present disclosure.

FIG. 17 is a schematic diagram of a result of inserting a first group adjustment control in a second group adjustment control according to an exemplary embodiment of the present disclosure.

FIG. 18 is a flowchart of a method for replacing an adjustment control by sliding according to an exemplary embodiment of the present disclosure.

FIG. 19 is a schematic diagram of a process of replacing a control by sliding according to an exemplary embodiment of the present disclosure.

FIG. 20 is a flowchart of a method for collapsing an adjustment control by sliding according to an exemplary embodiment of the present disclosure.

FIG. 21 is a schematic diagram of a process of collapsing an adjustment control by sliding according to an exemplary embodiment of the present disclosure.

FIG. 22 is a schematic diagram of display effects of an adjustment control in different states according to an exemplary embodiment of the present disclosure.

FIG. 23 is a structural block diagram of a control adjustment apparatus according to an exemplary embodiment of the present disclosure.

FIG. 24 is a structural block diagram of a control adjustment apparatus according to another exemplary embodiment of the present disclosure.

FIG. 25 is a structural block diagram of a computer device according to an exemplary embodiment of the present disclosure.

### DESCRIPTION OF EMBODIMENTS

The terms involved in embodiments of the present disclosure are briefly described.

User-generated content (UGC): content created by a user. The user presents created content of the user or provides the content to other users by using an Internet platform.

In a game application program or an application program based on a virtual scene, a user may participate in development of game content such as a game level, a game map, and gameplay by using some game mechanisms and corresponding UGC editing functions provided by the application program, to increase interest in a game process.

In some application programs that provide an interface editing capability or a UGC editing capability, a user can edit display content in a game by using the interface editing capability or the UGC editing capability provided by a system, for example, make a map, layout elements on the map, change positions of elements, or superimpose and combine elements.

In some cases, a UGC editing interface includes an element region and an element level adjustment region. The element region includes a virtual element, the element level adjustment region includes an adjustment control, and a correspondence exists between the adjustment control in the element level adjustment region and the virtual element in the element region. Through level adjustment for the adjustment control in the element level adjustment region, the user can perform level adjustment on the corresponding virtual element in the element region, that is, adjust a sequence of layers on which the virtual element is located in the element region. For example, a first adjustment control in the element level adjustment region has a correspondence with a first virtual element (text content) in the element region, and a second adjustment control in the element level adjustment region has a correspondence with a second virtual element (picture content) in the element region. The user places the first adjustment control on a layer above the second adjustment control by using the element level adjustment region, and displays the text content on the top of or on a layer above the picture content in the element region. That is, from a top-down perspective, the first virtual element is displayed first, and the second virtual element is displayed second.

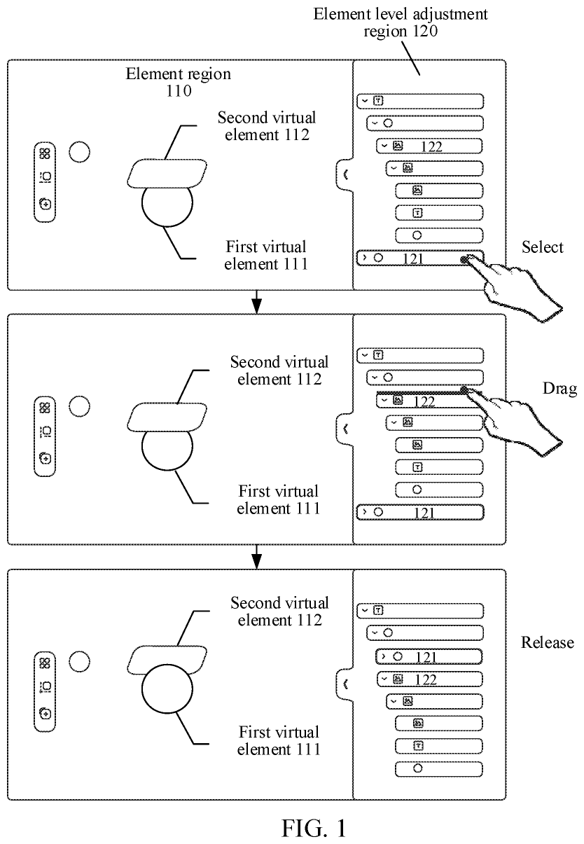

For example, FIG. 1 is a schematic diagram of adjusting a level of a virtual control.

The UGC editing interface includes an element region 110 and an element level adjustment region 120. The element region 110 includes a first virtual element 111 and a second virtual element 112, respectively corresponding to a first control 121 and a second control 122 in the element level adjustment region 120. The first virtual element 111 is located on a layer below the second virtual element 112.

The user selects the first control 121 and drags the first control 121 to directly above the second control 122, and in this case, a selected position corresponding to the second control 122 is displayed. The selected position is configured for indicating a level at which the first control 121 is located after the user releases the first control 121.

After the user releases the first control 121, the first control 121 is located on a layer above the second control 122, and the first virtual element 111 is also located on a layer above the second virtual element 112.

However, to intuitively represent a correspondence between control levels and element levels, controls are arranged in the element level adjustment region in a fixed direction. When adjusting the control level, the user drags the control in a control arrangement direction. When a quantity of controls included in the element level adjustment region is relatively large, the user needs to drag the control to move for a relatively long distance to adjust a control level, resulting in relatively low efficiency of control adjustment.

In some embodiments, the control list in the element level adjustment region may alternatively be partially folded, to reduce a length of the control list. When the user drags a control to adjust a level, a folded part is directly skipped, so that a drag distance of the user can be reduced to some extent.

However, the user needs to additionally perform a folding operation when dragging the control, and further needs to expand the folded control list after the control level is adjusted. This causes inconvenience to the user during control level adjustment, and the efficiency of human-computer interaction is low.

The present disclosure provides a control adjustment method, so that after a control whose level is to be adjusted is selected, accurate adjustment of a control level can be implemented by relying on only one slide operation based on slide vector components of the slide operation in different directions, a slide distance is reduced, a control list does not need to be frequently expanded or collapsed, and the efficiency of human-computer interaction during control adjustment can be improved.

The method may be applied to the following scenarios.
(1) Game application scenario: a game application program, software based on a virtual scene, an application program that can provide an interface editing capability, and the like.

In the game application scenario, a user may design and layout virtual elements in a game level, a game map, a virtual scene (for example, a user home in a game), and the like. An element region and an element level adjustment region are displayed on an interface. Elements in the element region may be superimposed, and the elements correspond to adjustment controls. A slide operation is performed on the adjustment controls in the element level adjustment region to adjust a control level, so that a layer sequence of the virtual elements in the element region/a level sequence in a direction perpendicular to a terminal interface can be adjusted.
(2) Image processing scenario: image processing software, and a platform or a website that can provide an image processing function.

In the image processing scenario, an image processing region and a control adjustment region are displayed on an interface. During image processing, the image may be divided into at least two superimposed layers, and each layer corresponds to an adjustment control. Control levels are adjusted by performing a slide operation on the adjustment control, to adjust a layer sequence of the layer in the image. For example, the image includes 15 layers, controls corresponding to the 15 layers are arranged in the control adjustment region from top to bottom, and each control corresponds to a different representation feature. An adjustment control corresponding to the 1^{st} layer is selected and slid, and a change process of representation features of different controls is displayed based on slide vector components of the slide operation in different directions, to determine a selected position of the adjustment control corresponding to the 1^{st} layer, to implement level adjustment.
(3) Drawing scenario: drawing software, and a platform or a website that can provide a drawing function.

In the drawing scenario, an image drawing region and a control adjustment region are displayed on an interface. When drawing an image, a user may create at least two layers or canvases. Each layer or canvas corresponds to an adjustment control. A slide operation is performed on the adjustment control to adjust a control level, so that a layer sequence of the layer or the canvas in the drawn image can be adjusted.

In some embodiments, an example in which the control adjustment method is applied to a game scenario is used for description. The user may participate in development of game content such as a game level, a game map, and gameplay by using a UGC editing capability provided in an application program (a game application program/an application program based on a virtual scene).

The terminal displays a UGC editing interface, and the user may edit a virtual element by operating a control on the UGC editing interface, or the user may directly edit the virtual element, for example, modify a form, an appearance, or a quantity of the virtual elements; control the virtual element to move; and create a virtual element by using a function provided by the application program.

In some embodiments, an editable virtual element includes a first virtual element. The user may modify a form of the first virtual element by performing an editing operation such as moving, rotating, or scaling on the editable virtual element. When the editable virtual element further includes a second virtual element, the user may further combine the first virtual element and the second virtual element into a virtual module.

Alternatively, the user may modify orientations of virtual elements, to construct a virtual module having a symmetrical structure, or the like.

Alternatively, the user may modify layers on which virtual elements are located, so that the virtual elements are displayed in a superimposing manner. For example, a layer of the first virtual element is placed above a layer of the second virtual element, so that the first virtual element is presented on the top of the second virtual element, and the second virtual element is presented on the bottom of the first virtual element.

An adjustment control corresponding to the editable virtual element exists in the UGC editing interface. The foregoing plurality of effects of editing the editable virtual elements can also be implemented by performing a corresponding operation on the adjustment control.

For example, the layer of the virtual element is adjusted by adjusting a control level of an adjustment control.

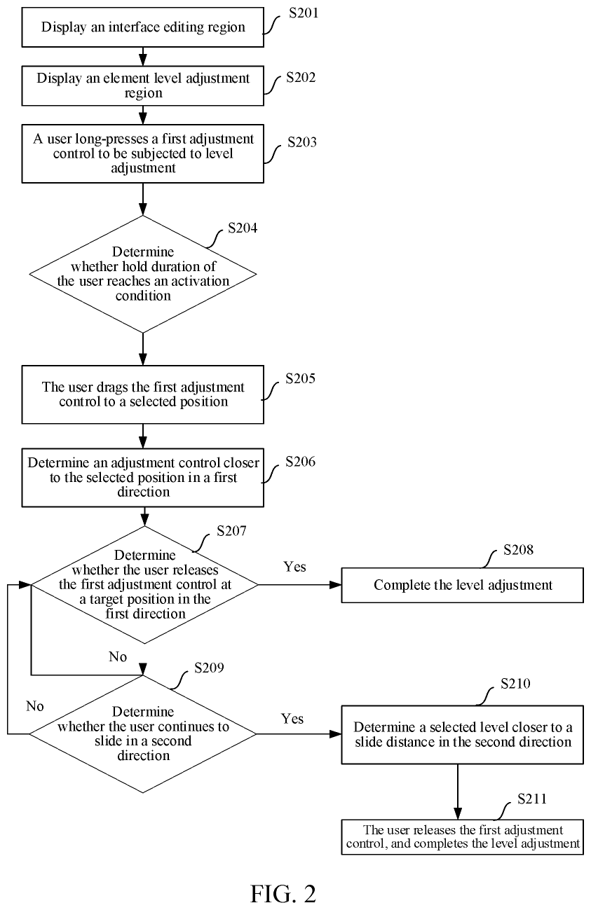

For example, FIG. 2 is a flowchart of a method for adjusting a control. An example in which the method is applied to a party casual game is used for description. The method includes the following operations.
S201: Display an interface editing region.

In the party casual game, a user may design a home by using a UGC editing function provided by a game application program, for example, plan purposes, architectural styles, and floor areas of different zones within the home, and freely arrange furniture, potted plants, pets, and the like.

When the user logs in to a main control account and controls a main control virtual role to enter the home, a terminal screen automatically displays a UGC editing interface corresponding to the home. That is, when the main control virtual role enters the home, the user can edit an editable virtual element existing in the garden.

A display element region and an interface editing region are displayed on the UGC editing interface. The interface editing region is configured for switching to display of the element level adjustment region.

The element region corresponds to a home region. The element region includes at least two virtual elements, the element level adjustment region includes at least two adjustment controls arranged in the first direction, and a correspondence exists between the virtual elements in the element region and adjustment controls in the element level adjustment region.

In some embodiments, the user may directly edit the virtual elements in the element region, or may edit the virtual elements by performing an adjustment operation on the adjustment control.

In some embodiments, types of operations of editing virtual elements include, but are not limited to:
(1) a mirroring operation: a virtual element is displayed in a mirroring manner in a symmetry direction or along a symmetry center;
(2) a copying operation: copying a virtual element; and
(3) a layer adjustment operation: each virtual element corresponds to a layer of the virtual element, the layer is configured for indicating a priority of a display status of the virtual element in a display region, and when positions of at least two virtual elements overlap, a virtual element on an upper layer is preferentially displayed.

For example, the element region includes a first virtual element and a second virtual element. Positions of the first virtual element and the second virtual element overlap in the element region. A layer of the first virtual element is located above a layer of the second virtual element. In this case, from a perspective of a direction perpendicular to a screen, the first virtual element is displayed on the top, and the second virtual element is displayed on the bottom. In a region in which the first virtual element and the second virtual element overlap, the first virtual element blocks the second virtual element.

The layer adjustment operation performed on the virtual element may be implemented by adjusting the level of the adjustment control in the element level adjustment region. A correspondence exists between layer sequences of the virtual elements in the display region and control levels of the adjustment controls in the element level adjustment region.

For example, the first virtual element and the second virtual element are on the same layer, and are displayed in parallel in the element region; and a first adjustment control corresponding to the first virtual element and a second adjustment control corresponding to the second virtual element in the element level adjustment region are at the same control level.

If the control level of the first adjustment control is adjusted, to cause a level of the adjusted first adjustment control to be lower than the level of the second adjustment control, correspondingly, the layer of the first virtual element is located below the layer of the second virtual element.
S202: Display an element level adjustment region.

The at least two adjustment controls include a first adjustment control, and the first adjustment control is configured to adjust a first virtual element among at least two virtual elements.
S203: A user long-presses the first adjustment control to be subjected to level adjustment.

In some embodiments, a long-press operation is performed on the first adjustment control, to select the first adjustment control and perform a level adjustment process on the first adjustment control.
S204: Determine whether hold duration of the user reaches an activation condition.

That is, whether duration for which the user holds the first adjustment control reaches a condition for activating level adjustment is determined.

For example, when the duration for which the user holds the first adjustment control reaches one second and the user does not release the first adjustment control, the condition for activating the level adjustment is met.

When the duration reaches the condition, operation S205 is performed.
S205: The user drags the first adjustment control to a selected position.

The adjustment controls in the element level adjustment region are arranged in the first direction, and the selected position is determined based on a slide vector component of the user in the first direction.
S206: Determine an adjustment control closer to the selected position in the first direction.

Each adjustment control corresponds to a control representation feature. When the selected position to which the user slides is closest to an adjustment control, the control representation feature corresponding to the adjustment control is displayed with a highlight effect, and control representation features of other adjustment controls are hidden.
S207: Determine whether the user releases the first adjustment control at the selected position in the first direction.

If the user releases the first adjustment control at the selected position, the slide operation ends, and operation S208 is performed.

If the user does not release the first adjustment control at the selected position, operation S209 is performed.
S208: Complete the level adjustment.

The first adjustment control after the level adjustment and an adjustment control whose control representation feature is displaying with a highlight effect have an adjacency relationship, and belong to the same level.

In some embodiments, the adjustment control whose control representation feature is a highlight effect is a group adjustment control, and the group adjustment control usually includes at least one component adjustment control. For example, a level of the group adjustment control is relatively high, and a level of the at least one component adjustment control subordinate to the group adjustment control is relatively low. An example in which the first adjustment control is a group adjustment control is used.

For example, when a group adjustment control A expands a component adjustment control B, if the group adjustment control A is located at a level above a first adjustment control C on which level adjustment needs to be performed, that the group adjustment control A and the first adjustment control C belong to the same level is displayed, and the first adjustment control C is located directly below the group adjustment control A and the expanded component adjustment control B. That is, in the element level adjustment region, a display sequence from top to bottom is: the group adjustment control A, the component adjustment control B, and the first adjustment control C.

In some embodiments, the component adjustment control B included in the group adjustment control A may be collapsed, and a display sequence from top to bottom after the level adjustment is: the group adjustment control A and the first adjustment control C.
S209: Determine whether the user continues to slide in a second direction.

The second direction is different from the first direction (for example, the second direction and the first direction are perpendicular to each other), and the selected position is updated based on a slide vector component of the user in the second direction.

Each adjustment control corresponds to a control representation feature. When the selected position to which the user slides is closest to an adjustment control, the control representation feature corresponding to the adjustment control is displayed with a highlight effect.

For example, an example in which the control representation feature is a dividing line feature is used for description. Adjustment controls at the same level correspond to the same length of dividing lines, and adjustment controls at different levels correspond to different lengths of dividing lines.

The length of the dividing line can be adjusted based on the slide vector component of the user in the second direction, so that the selected position is updated based on the length of the dividing line.

For example, in operation S206, it is determined that a currently selected position is close to a component adjustment control D, the component adjustment control D belongs to a group adjustment control E, a length of a dividing line of the component adjustment control D is two unit distances, and a length of a dividing line of the group adjustment control E is three unit distances.

If the slide vector component of the user in the second direction is one unit distance and the length of the dividing line is prolonged by a slide direction, after the selected position is updated, a corresponding adjustment control is the group adjustment control E.

If the user continues to slide in the second direction, operation S210 is performed.
S210: Determine a selected level closer to a slide distance in the second direction.

For example, the slide distance in the second direction causes a length of a dividing line displayed with a highlight effect to match the length of the dividing line of the group adjustment control E (that is, three unit distances), the selected level is a level to which the group adjustment control E belongs.
S211: The user releases the first adjustment control, and completes the level adjustment.

The first adjustment control after the level adjustment and an adjustment control displayed with a highlight effect have an adjacency relationship, and belong to the same level.

For example, an adjustment control displayed with a highlight effect is the group adjustment control E, and the first adjustment control after the level adjustment and the group adjustment control E have an adjacency relationship and belong to the same level.

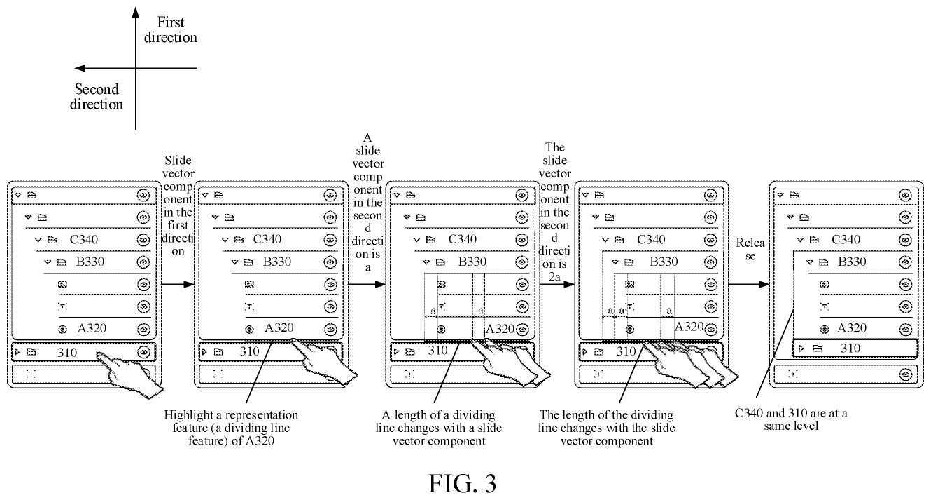

For example, FIG. 3 is a schematic diagram of a process of adjusting a component level based on slide vector components in different directions corresponding to FIG. 2.

The first adjustment control 310 is selected, and a slide operation is then performed. An adjustment control A320 corresponding to the selected position is determined based on a slide vector component of the slide operation in the first direction. The adjustment control A320 is a component adjustment control, the adjustment control A320 belongs to a group adjustment control B330, and the group adjustment control B330 belongs to a group adjustment control C340.

When the slide is performed to the selected position, a highlight effect is used as a control representation feature of the adjustment control A320 and is displayed. An example in which the control representation feature is a dividing line feature is used, and dividing line features of the adjustment control A320, the group adjustment control B330, and the group adjustment control C340 respectively correspond to different lengths, such as d, d+a, and d+2a, where a and d are positive numbers.

In some embodiments, a slide vector component of the slide operation also exists in the second direction, and it is displayed, based on the slide vector component in the second direction, that the length of the dividing line changes with the slide vector component.

When the slide vector component is a unit distance a, a change in the length of the dividing line is a. An example in which the second direction is a horizontally leftward direction is used. As shown in FIG. 3, because the group adjustment control and the component adjustment control are arranged in a manner of being horizontally rightward aligned, when the second direction is the horizontally leftward direction, the length of the dividing line is correspondingly increased. Similarly, when the second direction is a horizontally rightward direction, the length of the dividing line is correspondingly decreased.

When the slide vector component is the unit distance a, the length of the dividing line is d+a, which is the same as the length of the dividing line corresponding to the group adjustment control B330. If the user release the first adjustment control 310 in this case, the first adjustment control 310 and the group adjustment control B330 have an adjacency relationship and belong to the same level.

When the slide vector component is two unit distances 2a, the length of the dividing line is d+2a, which is the same as the length of the dividing line corresponding to the group adjustment control C340. If the user release the first adjustment control 310 in this case, the first adjustment control 310 and the group adjustment control B330 have an adjacency relationship and belong to the same level.

In some embodiments, in FIG. 3, when the slide vector component is two unit distances, the user releases the first adjustment control 310, and the first adjustment control 310 and the group adjustment control B330 have an adjacency relationship and belong to the same level.

When the group adjustment control B330 and the group adjustment control C340 are in an expanded state, the first adjustment control 310 is adjacent to a component adjustment control (which is the adjustment control A320 in FIG. 3) located at the lowest level in the group adjustment control B330 and the group adjustment control C340.

In conclusion, according to the method provided in the present disclosure, control adjustment efficiency can be improved when the number of adjustment controls in an element level adjustment region is relatively large. In this way, the user does not need to frequently collapse or expand the control list and then adjust the control. The control can be accurately adjusted based on only slide vector components of the same slide operation in different directions, thereby improving the efficiency of human-computer interaction.

A terminal in the present disclosure may be a desktop computer, a laptop computer, a mobile phone, a tablet computer, an e-book reader, a moving picture experts group audio layer III (MP3) player, a moving picture experts group audio layer IV (MP4) player, or the like. An application program supporting a virtual scene, for example, an application program supporting a three-dimensional virtual scene, is installed and run on the terminal. The application program may be any one of a virtual reality application program, a three-dimensional map program, a simulation game (SLG), a third-person shooter (TPS) game, a first-person shooter (FPS) game, a multiplayer online battle arena (MOBA) game, a party casual game, a tower defense game, or a social game. In some embodiments, the application program may be a standalone application program, for example, a standalone three-dimensional game program, or may be a network-connected application program.

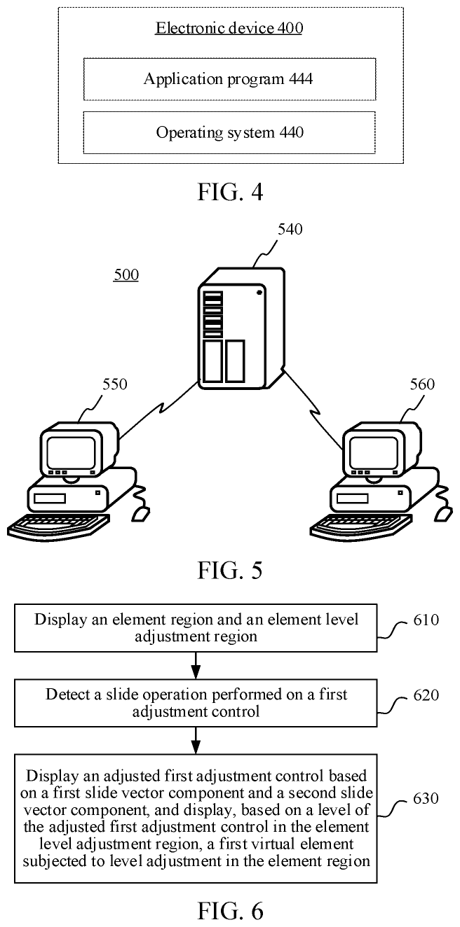

FIG. 4 is a structural block diagram of an electronic device according to an exemplary embodiment of the present disclosure. An electronic device 400 includes: an operating system 440 and an application program 444.

The operating system 440 is basic software provided for the application program 444 to perform secure access to computer hardware.

The application program 444 is an application program supporting a virtual scene. In some embodiments, the application 444 is an application supporting a three-dimensional virtual scene. The application program 444 may be any one of a virtual reality application program, a three-dimensional map program, an SLG game, a TPS game, an FPS game, a MOBA game, a party casual game, a tower defense game, or a social game. The application program 444 may be a standalone application program, for example, a standalone three-dimensional game program, or may be a network-connected application program.

FIG. 5 is a structural block diagram of a computer system according to an exemplary embodiment of the present disclosure. A computer system 500 includes: a first device 550, a server 540, and a second device 560.

An application program supporting a virtual scene is installed and run on the first device 550. The application program may be any one of a virtual reality application program, a three-dimensional map program, a TPS game, an FPS game, a MOBA game, an SLG game, a party casual game, or a tower defense game. The first device 550 is a device used by a first user. The first user uses the first device 550 to control a first virtual object in the virtual scene to perform an action. The action includes, but is not limited to: at least one of body posture adjustment, walking, running, jumping, or attacking. For example, the first virtual object is a first virtual character, such as a simulated character role or an animation character role.

The first device 550 is connected to the server 540 through a wireless network or a wired network.

The server 540 includes at least one of one server, a plurality of servers, a cloud computing platform, or a virtualization center. The server 540 is configured to provide a backend service for an application program supporting a virtual scene. In some embodiments, the server 540 is responsible for primary computing work, and the first device 550 and the second device 560 are responsible for secondary computing work. Alternatively, the server 540 is responsible for secondary computing work, and the first device 550 and the second device 560 are responsible for primary computing work. Alternatively, the server 540, the first device 550, and the second device 560 perform collaborative computing by using a distributed computing architecture among each other.

The server 540 controls a second virtual object in the virtual scene to perform an action. The action includes, but is not limited to: at least one of body posture adjustment, walking, running, jumping, or attacking. For example, the second virtual object may be a second virtual character, such as a simulated character role or an animation character role.

An application program supporting a virtual scene is installed and run on the second device 560. The application program may be any one of a virtual reality application program, a three-dimensional map program, an FPS game, a MOBA game, an SLG game, a party casual game, or a tower defense game. The second device 560 is a device used by a second user. The second user uses the second device 560 to control a third virtual object in the virtual scene to perform an action. The action includes, but is not limited to: at least one of body posture adjustment, walking, running, jumping, or attacking. For example, the third virtual object is a third virtual character, such as a simulated character role or an animation character role.

In some embodiments, the application programs installed on the first device 550 and the second device 560 are the same, or the application programs installed on the two devices are the same type of application programs on different control system platforms. The first device 550 may generally refer to one of at least two devices, and the second device 560 may generally refer to one of at least two devices. This embodiment is described by using only the first device 550 and the second device 560 as examples. Device types of the first device 550 and the second device 560 are the same or different. In the following embodiments, description is made by using an example in which the device is a desktop computer.

A person skilled in the art may know that there may be more or fewer devices. For example, there may be only one device, or there may be dozens, hundreds, or more devices. A quantity of devices and the device type are not limited in the embodiments of the present disclosure.

The server 540 may be implemented as a physical server, or may be implemented as a cloud server in the cloud. In some embodiments, a method provided in the embodiments of the present disclosure may be applied to a cloud game scene, so that the cloud server completes computing of data logic in a game process, and a terminal is responsible for displaying a game interface.

The control adjustment method provided in the present disclosure is described with reference to the above term introduction and application scenarios. The method may be performed by a server or a terminal or jointly by the server and the terminal. In this embodiment of the present disclosure, an example in which the method is performed by the terminal is used for description, as shown in FIG. 6. FIG. 6 is a flowchart of a control adjustment method according to an exemplary embodiment of the present disclosure. The method includes the following operations.

Operation 610: Display an element region and an element level adjustment region.

An application program providing a UGC editing capability is installed on the terminal, and a user may participate in development of game content such as a game level, a game map, and gameplay by using a UGC editing function. For example, the terminal displays a UGC editing interface. The UGC editing interface includes an element region and an element level adjustment region. The user may perform a related operation on the UGC editing interface, to customize display of game content.

The element region includes at least two virtual elements, and the element level adjustment region includes at least two adjustment controls arranged in a first direction.

In some embodiments, there is a level relationship of level nesting between the at least two virtual elements. The element level adjustment region includes at least two adjustment controls arranged in the first direction, and positions of the adjustment controls in the element level adjustment region correspond to levels of the virtual elements.

For example, 20 adjustment controls are arranged in the first direction, and an arrangement manner of the adjustment controls is periodic. For example, every 5 adjustment controls is an adjustment period.

For example, [period 1-control 1, period 1-control 2, period 1-control 3, period 1-control 4, period 1-control 5] is one arrangement period; and [period 2-control 1, period 2-control 2, period 2-control 3, period 2-control 4, period 2-control 5] is a next arrangement period. After the period 1-control 2 is selected through adjustment in the first direction, any control in the period 1 may be further selected through adjustment in the second direction; or after the period 1-control 2 is selected through adjustment in the second direction, any control 2 in periods may be selected through adjustment in the first direction.

In some other embodiments, some elements in the at least two virtual elements belong to the same level, that is, some elements are in a parallel relationship. In this case, the element level adjustment region further includes a group control, adjustment controls corresponding to the virtual elements in the parallel relationship are in a group of the same group control, and a level of a corresponding virtual element in the element region is expressed by using positions of the group controls in the element level adjustment region.

For example, a group control 1 and a group control 2 are in parallel, and are at a level 1. The group control 1 includes an adjustment control 3, the group control 2 includes an adjustment control 4, and the adjustment control 3 and the adjustment control 4 are at a level 2.

In some embodiments, types of virtual elements include, but are not limited to the following several types.
(1) Virtual picture element: a picture, such as an animated image, a static image, or a video frame, is inserted in the element region and is displayed;
(2) virtual text element: a paragraph of text content, for example, static text information or scrolling text information is displayed in the element region;
(3) virtual object element: 1. a two-dimensional object: for example, a two-dimensional pattern (including, but not limited to: a watermark pattern generated by a system/customized by a user), or a two-dimensional geometric figure (including, but not limited to: a rectangle, a square, a triangle, and a circle); and 2. three-dimensional object: for example, a three-dimensional geometry (including, but not limited to: a cuboid, a cube, a cone, a triangular pyramid, and a sphere), a building element (including, but not limited to: a home and a furniture constructed by a user in a virtual scene), a virtual plant element (including, but not limited to: a flower, a tree, and a lawn in a virtual scene), and an obstacle element (including, but not limited to: a road block and a trap set by a user in a game level or a game map);
(4) virtual button element: a specific function can be implemented after the virtual button element is triggered, for example, a first virtual button element has a mirroring function, and can mirror an object within a range of the button (for example, flipping an object within a range of the button along a vertical axis); or a second virtual button element has a rebound function, and can rebound an object within a range of the button by a preset distance; and
(5) virtual background element: configured to set a background in the element region, for example, set a color, a special effect, or a sound effect.

In some embodiments, the first direction is a vertical axis direction (a Y-axis direction in an XY coordinate system), the at least two adjustment controls in the element level adjustment region are arranged in a sequence from top to bottom, and each adjustment control corresponds to a unique control identifier. For example, the control identifier includes at least one of a control sequence number, a level to which the control belongs, and a virtual element corresponding to the control, or the control identifier is an identifier customized by the user.

The virtual element in the element region corresponds to the adjustment control in the element level adjustment region.

The virtual element in the element region corresponds to an element layer, the element layer is configured for representing a level status of the virtual element when the virtual element is displayed in the element region. The adjustment control in the element level adjustment region corresponds to a control level, and the control level is configured for representing a control subordination relationship of the adjustment control in the element level adjustment region. A sequence of element layers corresponding to virtual elements has a correspondence with control levels of adjustment controls.

In some embodiments, an editable virtual element exists in the element region, and the editable virtual element corresponds to an adjustment control in the element level adjustment region.

Through a process of adjusting the level of the adjustment control in the element level adjustment region, the element layer sequence of the virtual element in the element region can be correspondingly adjusted, so that the virtual elements in the element region can superimpose each other, to increase a structure hierarchy of content displayed in the element region. For a virtual element having a relatively large volume or occupying a relatively large area, the element layer of the virtual element is indirectly adjusted by using the adjustment control to adjust a level, so that the virtual element can be quickly positioned when the virtual element is blocked due to different element layers of virtual elements. The user does not need to repeatedly drag a virtual element already arranged at a position in the element region, thereby improving the efficiency of human-computer interaction.

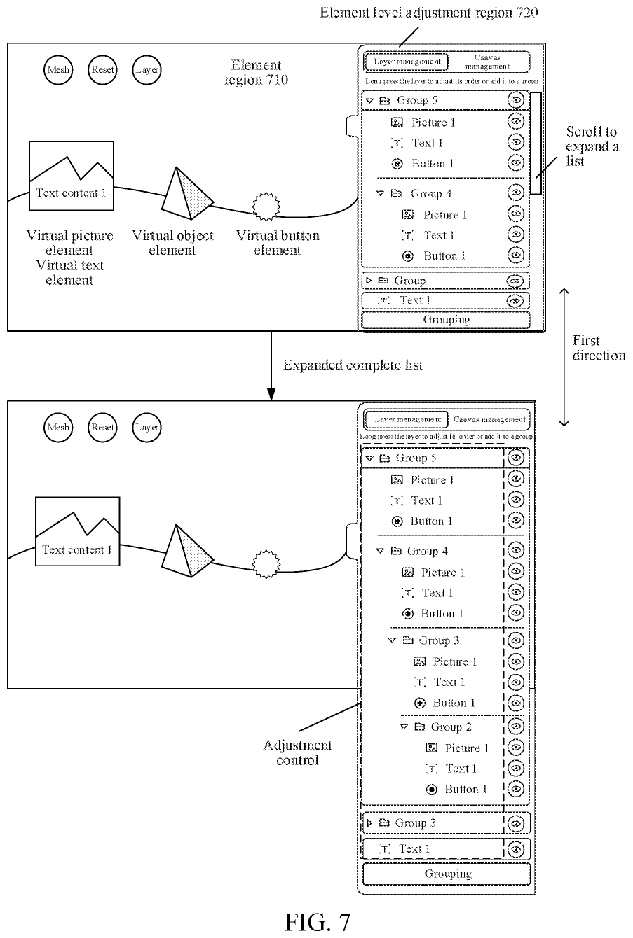

For example, FIG. 7 is a schematic diagram of an element region and an element level adjustment region.

The element region 710 includes a plurality of types of virtual elements, for example, a virtual picture element, a virtual object element, a virtual button element, and a virtual text element (text content 1) located on a layer above the virtual picture element. The element level adjustment region 720 is configured for managing an element layer of a virtual element in the element region 710.

The element level adjustment region 720 includes at least two adjustment controls corresponding to the virtual elements, and the adjustment controls are arranged in a sequence in the first direction. The element level adjustment region 720 may directly display only a part of the adjustment controls, and the user may expand a complete control list by using a scroll control, to view another part of adjustment controls that are hidden.

The at least two adjustment controls include a first adjustment control, and the first adjustment control is configured to adjust a first virtual element among at least two virtual elements.

Operation 620: Receive a slide operation performed on the first adjustment control.

The slide operation includes a first slide vector component in the first direction and a second slide vector component in the second direction. The first direction and the second direction are different directions.

In some embodiments, the first direction is the vertical axis direction (the Y-axis direction in the XY coordinate system), the second direction is a horizontal axis direction (an X-axis direction in the XY coordinate system), and the first direction and the second direction are perpendicular to each other.

For example, the slide operation may include at least two slide stages, for example, a first slide stage and a second slide stage. At the first slide stage, the slide operation is performed in the first direction, and corresponds to the first slide vector component; and at the second slide stage, the slide operation is performed in the second direction, corresponding to the second slide vector component. The first slide stage is connected to the second slide stage, and the user does not release the first adjustment control in a slide process.

For example, the slide operation includes only one slide stage. For example, the slide operation is performed in a preset direction, and the first slide vector component is determined based on an angle between the preset direction and the first direction and a slide distance of the slide operation; and the second slide vector component is determined based on an angle between the preset direction and the second direction and the slide distance of the slide operation.

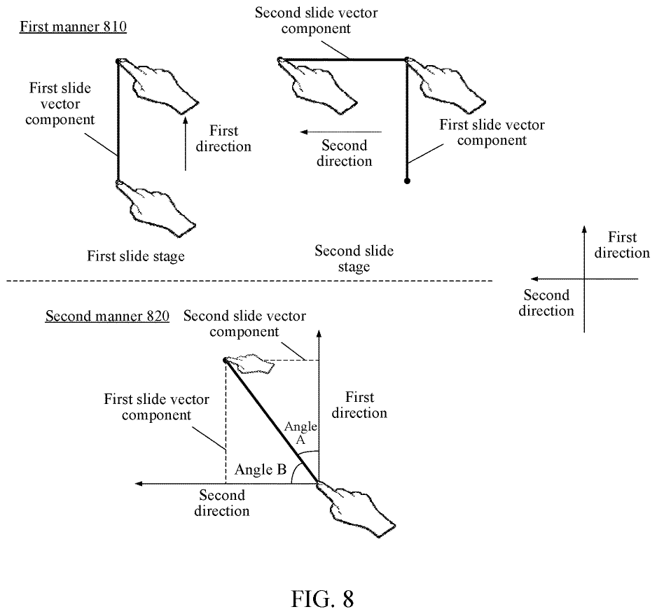

For example, FIG. 8 is a schematic diagram of two manners of determining a slide vector component.

First manner 810: A direction at each slide stage is any one of the first direction or the second direction, and a slide distance in each direction is used as a slide vector component in the direction.

In a slide process, if the user directly follows the first direction and the second direction to perform the slide operation at different slide stages, to adjust a control, the selected position of the first adjustment control can be seen more intuitively, and a display effect after the control is adjusted can be learned, thereby improving efficiency of control adjustment. A distance indicated by the slide stage is used as the slide vector component, so that accuracy of slide data can be improved, an adjustment control can be accurately adjusted, a computer resource can be saved, and an effect of control adjustment can be improved.

Second manner 820: The angle between the slide direction and the first direction is A, and the first slide vector component in the first direction is obtained based on a product of the slide distance and a cosine value of the angle A; and the angle between the slide direction and the second direction is B, and the second slide vector component in the second direction is obtained based on a product of the slide distance and a cosine value of the angle B.

In some embodiments, when the slide vector component is determined in the second manner 820, a slide track of the slide operation may not be a straight line, and a connecting line between a start point and an end point of the slide operation may be used as a basis for determining the angle and the slide vector component.

In the slide process, the user may alternatively freely slide, and the slide process does not need to be divided into two stages based on a sequence, thereby reducing operation pressure of the user. A slide in the same direction generates two slide vector components, so that a slide distance and operation duration can be reduced, and efficiency of control adjustment can be improved.

Operation 630: Display an adjusted first adjustment control based on the first slide vector component and the second slide vector component, and display, based on a level of the adjusted first adjustment control in the element level adjustment region, the first virtual element subjected to level adjustment in the element region.

In some embodiments, a first control position is determined in the first direction based on the first slide vector component. The first control position corresponds to at least one candidate control.

The first control position is a selected position in which the first adjustment control is to be inserted. The selected position corresponds to at least one adjacent candidate control. After being slid to the selected position, the first adjustment control has an adjacency relationship with the at least one candidate control, and the first adjustment control and the at least one candidate control are at the same level.

For example, the first direction is the vertical axis direction, and n adjustment controls are arranged in the first direction from top to bottom. The first slide vector component of the slide operation exists in an upward direction of the axis direction, and the first slide vector component corresponds to the first control position.

If the first control position is located directly above an i^{th} adjustment control in the n adjustment controls, the at least one candidate control corresponding to the first control position is the i^{th} adjustment control and all adjustment controls above the i^{th} adjustment control (that is, the 1^{st} adjustment control to the i^{th} adjustment control). i and n are positive integers.

A second adjustment control is determined from the at least one candidate control based on the second slide vector component, and the adjusted first adjustment control is displayed based on a control level to which the second adjustment control belongs. A level of the adjusted first adjustment control is the same as the control level to which the second adjustment control belongs.

For example, in a process of analyzing a displayed selected position of the first adjustment control, the first control position at which the slide operation ends is first determined in the first direction by using the first slide vector component, and then the second adjustment control is targetedly determined from the at least one candidate control corresponding to the first control position with reference to the second slide vector component, so that when the adjusted first adjustment control is displayed, the level of the adjusted first adjustment control is targetedly determined by using the control level to which the second adjustment control belongs.

In some embodiments, a second control position may be further determined in the second direction based on the second slide vector component, and then the second adjustment control is determined, based on the first slide vector component, from the at least one candidate control corresponding to the second control position, to display the adjusted first adjustment control based on the control level to which the second adjustment control belongs. In this case, the second control position at which the slide operation ends is first determined in the second direction by using the second slide vector component, and then the second adjustment control is targetedly determined in the at least one candidate control corresponding to the second control position with reference to the first slide vector component, so that the level of the adjusted first adjustment control is targetedly determined by using the control level to which the second adjustment control belongs.

That is, in a process of displaying the adjusted first adjustment control based on the first slide vector component and the second slide vector component, a first slide vector may be first analyzed and the second slide vector is then analyzed, or the second slide vector may be first analyzed and the first slide vector is then analyzed. The analysis process has strong analysis flexibility, helps precisely perform control adjustment, and also helps to provide more natural and intuitive user experience, thereby improving display flexibility of the adjustment control.

Determining the selected position of the first adjustment control by using slide vector components in at least two directions, compared with a manner in which the user drags only in the same direction, can reduce a distance for which the user drags the adjustment control to move and time spent on the operation, thereby improving the efficiency of human-computer interaction. When there are a large number of controls, some adjustment controls that do not meet the condition may be skipped by using slide vector components in different slide directions, to reach the selected position. A complex operation of frequently collapsing and expanding the control list is not needed, which can provide strong convenience to a user operation.

In some embodiments, the at least two adjustment controls respectively correspond to control representation features, and during the slide operation, a highlight effect is displayed and switched between the at least one candidate control based on the second slide vector component as a control representation feature respectively corresponding to the at least one candidate control.

In response to that the second slide vector component ends, a candidate control whose control representation feature is the highlight effect among the at least one candidate control is used as the second adjustment control.

For example, the control representation feature is configured for representing a display style of the adjustment control in the element level adjustment region. After the candidate control corresponding to the first control position is determined based on the first slide vector component in the first direction, the control representation feature corresponding to the at least one candidate control passed by the second slide vector component may be flexibly displayed with a highlight effect by using a distance of sliding in the second direction indicated by the second slide vector component. The highlight effect includes at least one of a plurality of special display styles such as color highlight (for example, a default effect is gray, and the color highlight is yellow) and font highlight (for example, a default effect is a medium font size, and the font highlight is a large font size).

Switching representation of the control representation feature with a highlight effect can clearly and intuitively indicate a position passed in the control adjustment process, helping the user to targetedly select the second adjustment control from the at least one candidate control, thereby improving efficiency in the control adjustment process.

The types of the control representation features include, but are not limited to: (1) a dividing line feature, displayed at an edge of each adjustment control, where dividing lines corresponding to adjustment controls belonging to different control levels have different lengths; (2) a color feature, where adjustment controls belonging to different control levels correspond to different control colors; (3) an identification feature, where adjustment controls belonging to different control levels correspond to different control identifiers, for example, the control identifier is implemented as at least one of a naming format, a control name, a control thumbnail, or the like of each adjustment control; and (4) a control length feature, where adjustment controls belonging to different control levels correspond to different control lengths.

Different control representation features can function as a prompt in a process in which the user adjusts a control, so that the user can understand a method and skill for adjusting a control, and the user is guided to continue a subsequent operation to reach an expected adjustment target, thereby improving the efficiency of human-computer interaction. In addition, the control representation feature can also increase richness of a displayed picture.

For example, the control representation feature includes a dividing line feature. The dividing line feature is used as an example for description.

A dividing line feature of a selected candidate control is displayed based on the second slide vector component, and a dividing line feature of an unselected candidate control is hidden. The second adjustment control is determined from the at least one candidate control based on a display status of the dividing line feature.

The manner of using the dividing line feature as the control representation feature for distinguishing candidate controls is relatively simple and intuitive, so that a corresponding control can be determined based on a hiding/displaying status of the dividing line. The dividing line occupies a small proportion in the picture, which can save space in the element level adjustment region, avoid congested picture, and reduce resources consumed by a computer when the computer loads the picture.

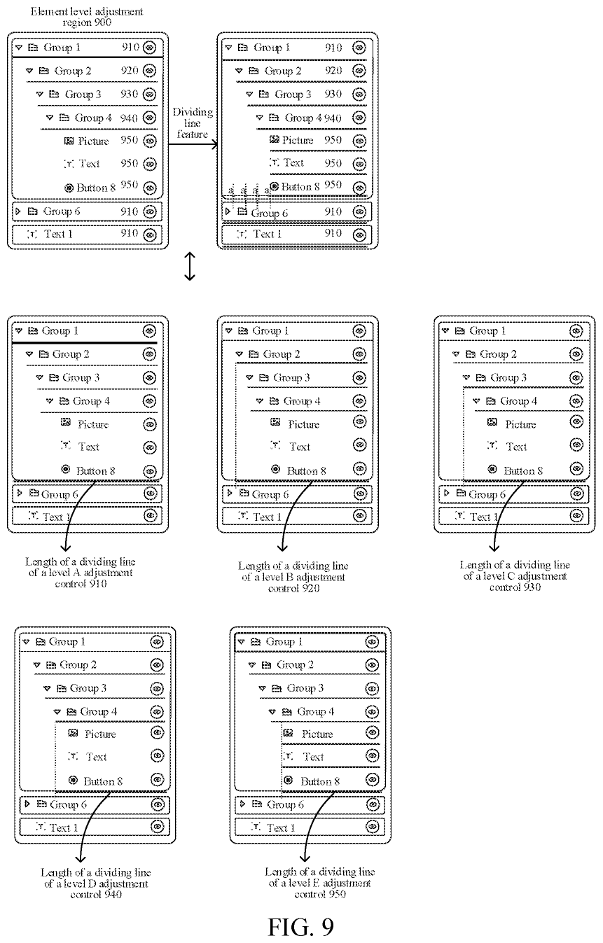

For example, FIG. 9 is a schematic diagram of displaying a dividing line feature based on a second slide vector component.

An element level adjustment region 900 includes adjustment controls at five levels, which are respectively: a level A adjustment control 910, a level B adjustment control 920, a level C adjustment control 930, a level D adjustment control 940, and a level E adjustment control 950. The adjustment control at each level corresponds to a respective dividing line feature, and adjustment controls at different levels have different dividing line lengths.

For example, in FIG. 9, lengths of the dividing lines are as follows: the level A adjustment control 910>the level B adjustment control 920>the level C adjustment control 930 >the level D adjustment control 940>the level E adjustment control 950.

In some embodiments, a difference between lengths of dividing lines corresponding to adjacent levels is a preset threshold a, where a is a positive number, and a unit may be arbitrary. For example, a difference between the length of the dividing line of the level A adjustment control 910 and the length of the dividing line of the level B adjustment control 920 is the preset threshold a; and a difference between the length of the dividing line of the level A adjustment control 910 and the length of the dividing line of the level C adjustment control 930 is two times the preset threshold a, that is, 2a, or the like.

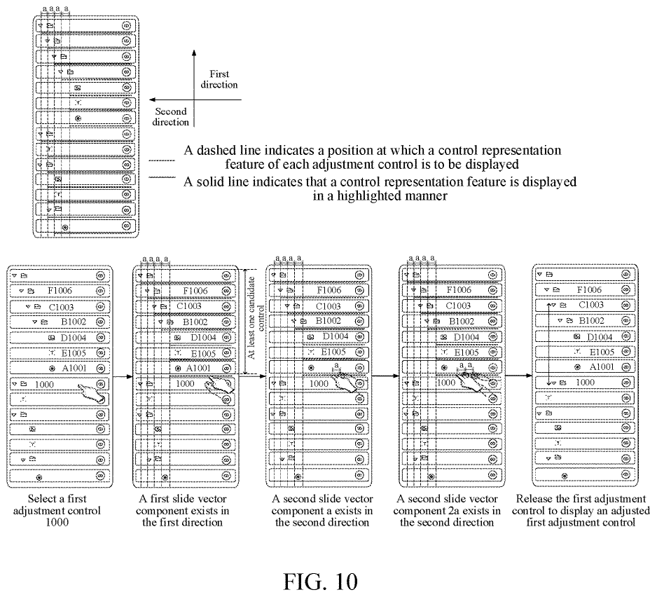

For example, FIG. 10 is a schematic diagram of a process of displaying an adjusted first adjustment control based on a first slide vector component and a second slide vector component.

In FIG. 10, a dashed line is used to represent a length of a dividing line respectively corresponding to each adjustment control and a position at which the dividing line is highlighted, and a solid line is used to represent display of a dividing line feature with a highlight effect.

The user selects and moves a first adjustment control 1000 in the first direction (upward), and determines the first control position based on the first slide vector component. The first control position corresponds to an adjustment control A1001, and a dividing line feature of the adjustment control A1001 is highlighted. It is determined that the at least one candidate control is the adjustment control A1001 and an adjustment control above the adjustment control A1001. The first adjustment control 1000 is continuously moved in the second direction (leftward), and the second adjustment control is determined based on the second slide vector component. When the second slide vector component is a, a dividing line feature of an adjustment control B1002 is highlighted, and when the second slide vector component is 2a, a dividing line feature of an adjustment control C1003 is highlighted. The adjustment control C1003 includes the adjustment control B1002, and the adjustment control B1002 includes the adjustment control A1001.

The user releases the first adjustment control 1000 when the second slide vector component is 2a, and determines that the second adjustment control is the adjustment control C1003, and an adjusted first adjustment control 1000 is displayed. The adjusted first adjustment control 1000 and the adjustment control C1003 belong to the same layer and have an adjacency relationship. Because the adjustment control C1003 expands the included adjustment control B1002, and the adjustment control B1002 also expands the included adjustment control A1001, adjustment control D1004, and adjustment control E1005, the adjusted first adjustment control 1000 is adjacent to the adjustment control A1001 on the lowest layer in the expanded list.

Because the adjustment control C1003 belongs to an adjustment control F1006, by analogy, the adjusted first adjustment control 1000 also belongs to the adjustment control F1006.

In some embodiments, the candidate control may be first determined based on the second slide vector component, and the second adjustment control is then determined from the candidate control based on the first slide vector component, thereby implementing level adjustment for the first adjustment control.

A plurality of manners of determining the slide vector component and determining the second adjustment control based on the slide vector component can all accurately adjust a control when the user slides in any manner, thereby improving the efficiency of human-computer interaction.

In some embodiments, the at least two adjustment controls included in the element level adjustment region respectively correspond to the control representation features. After the slide operation is received, the first control level is determined from the at least two control levels based on the second slide vector component.

The at least two control levels are sets of levels to which the at least two adjustment controls respectively belong. For example, an adjustment control A and an adjustment control B belong to a control level 1, and an adjustment control C belongs to a control level 2. The at least two adjustment controls include the adjustment control A, the adjustment control B, and the adjustment control C, and the at least two control levels include the control level 1 and the control level 2.

A subordination relationship exists between at least two control levels. For example, if the control level 2 is subordinate to the control level 1, an adjustment control C is subordinate to the control level 2 and the control level 1.

For example, the at least two control levels having a subordination relationship are usually arranged in a staggered manner. As shown in FIG. 9, the “group 2” subordinate to the “group 1” is arranged in a staggered manner with the “group 1”. Similarly, “image”, “text”, and the like subordinate to the “group 4” are also arranged in a staggered manner with the group “4”, to more intuitively display a subordination relationship between control levels.

The second slide vector component represents a vector component distance of the slide operation in the second direction. After the second slide vector component is determined based on the slide operation, a first control component is determined from the at least two control levels having a level relationship by using the second slide vector component, and the first control level matches a distance vector component in the second direction indicated by the second slide vector component.

At least one adjustment control having the first control level has a first control representation feature.

For example, the at least two adjustment controls include at least one adjustment control having the first control level, and the first control representation feature is used to represent at least one adjustment control having the first control level. For example, the first control representation feature is “a dividing line feature in a solid line form”, and the dividing line feature in a solid line form is displayed below the at least one adjustment control having the first control level.

For example, an example in which the control representation feature is a dividing line feature is used for description. The at least two adjustment controls respectively correspond to five control levels: (1) the level E adjustment control: when the second slide vector component is (0, d], a level E is used as the first control level determined based on the second slide vector component, the first control representation feature corresponding to the level E adjustment control is displayed (that is, an adjustment control having the level E is displayed with the first control representation feature), and the adjustment control belonging to the level E is used as a to-be-analyzed candidate control; (2) the level D adjustment control: when the second slide vector component is (d, d+a], a level D is used as the first control level determined based on the second slide vector component, the first control representation feature corresponding to the level D adjustment control is displayed (that is, an adjustment control having the level D is displayed with the first control representation feature), and the adjustment control belonging to the level D is used as a to-be-analyzed candidate control; (3) the level C adjustment control: when the second slide vector component is (d+a, d+2a], a level C is used as the first control level determined based on the second slide vector component, the first control representation feature corresponding to the level C adjustment control is displayed (that is, an adjustment control having the level C is displayed with the first control representation feature), and the adjustment control belonging to the level C is used as a to-be-analyzed candidate control; (4) the level B adjustment control: when the second slide vector component is (d+2a, d+3a], a level B is used as the first control level determined based on the second slide vector component, the first control representation feature corresponding to the level B adjustment control is displayed (that is, an adjustment control having the level B is displayed with the first control representation feature), and the adjustment control belonging to the level B is used as a to-be-analyzed candidate control; and (5) the level D adjustment control: when the second slide vector component is (d+3a, d+4a], a level D is used as the first control level determined based on the second slide vector component, the first control representation feature corresponding to the level D adjustment control is displayed (that is, an adjustment control having the level D is displayed with the first control representation feature), and the adjustment control belonging to the level D is used as a to-be-analyzed candidate control. d is a positive number.

For example, the second slide vector component is d+3a, an adjustment control belonging to the level B is used as a to-be-analyzed candidate control, and the adjustment control belonging to the level B is displayed with the first control representation feature, for example, the adjustment control belonging to the level B is displayed with a highlight effect.

In some embodiments, a third adjustment control having the first control representation feature is determined based on the first slide vector component in the first direction, where the third adjustment control has the first control level; and the adjusted first adjustment control is displayed based on the first control level to which the third adjustment control belongs, where the level of the adjusted first adjustment control is the first control level corresponding to the third adjustment control.

In some embodiments, any one of the at least one adjustment control having the first control representation feature is used as a start point of the first slide vector component, and the third adjustment control is determined based on the first slide vector component.

For example, the first direction is a vertical axis direction, and adjustment controls belonging to the level B are arranged in the first direction from top to bottom, and are respectively: an adjustment control 1, an adjustment control 2, and an adjustment control 3. The adjustment control 2 is used as the start point of the first slide vector component.

When the first slide vector component is (0, m], the start point (the adjustment control 2) is determined as the third adjustment control; when an upward vector component of the first slide vector component in the first direction is (m, 2m], the adjustment control 1 is determined as the third adjustment control; or when a downward vector component of the first slide vector component in the first direction is (m, 2m], the adjustment control 3 is determined as the third adjustment control.

For example, the first control level corresponding to the third adjustment control is used as the level of the adjusted first adjustment control. In addition, the first adjustment control may be flexibly displayed based on a position of the third adjustment control. For example, the first adjustment control is displayed above the third adjustment control, that is, the third adjustment control and the first adjustment control belong to the same level and are located above the third adjustment control. Alternatively, the first adjustment control is displayed below the third adjustment control, that is, the third adjustment control and the first adjustment control belong to the same level and are located below the third adjustment control. This is not limited herein.

Herein, it is described that the first control level is first determined based on the second slide vector component, and the third adjustment control is then determined from the adjustment controls at the first control level based on the first slide vector component, to determine content displayed at the level of the adjusted first adjustment level. This process helps to achieve precise control of levels and efficient user interaction, and helps to provide a more intuitive and ordered interaction process, to enable the user to balance selection in a large range and adjustment of details. This process also helps to improve analysis and calculation efficiency of a computer, helps the user to achieve more precise feedback and control, and enhances a response speed and operation flexibility of the terminal.

In some embodiments, in a process in which the user selects the first adjustment control and performs the slide, the user may alternatively cancel the level adjustment operation performed on the first adjustment control.

In some embodiments, after the slide operation performed on the first adjustment control is received, in response to a slide distance corresponding to the slide operation meeting a control adjustment cancellation condition, position adjustment for the first adjustment control in the element level adjustment region is canceled, and adjustment cancellation prompt information is correspondingly displayed. Display of the first adjustment control in the element level adjustment region and the first virtual element in the element region is maintained.

For example, the control adjustment cancellation condition is a preset condition configured for automatically triggering cancellation of an adjustment and control process of the adjustment control. In some embodiments, the control adjustment cancellation condition is that the slide distance of the slide operation reaches a preset distance threshold; or the control adjustment cancellation condition is that slide duration of the slide operation reaches a preset duration threshold; or the control adjustment cancellation condition is that a slide track of the slide operation does not conform to a preset shape (such as a straight-line or a sectoral track). This is not limited herein.

For example, the adjustment cancellation prompt information is prompt information configured for prompting that an adjustment process of the adjustment control is canceled. For example, the adjustment cancellation prompt information is text information “The adjustment has been canceled”; or the adjustment cancellation prompt information may be edge highlight information (for example, a terminal screen is displayed in a red highlight style), or the like. This is not limited herein.

For example, as shown in FIG. 7, when the user releases the first adjustment control after sliding to the element region 710, a slide distance meets the control adjustment cancellation condition, and adjustment of the first adjustment control is canceled and the adjustment cancellation prompt information is correspondingly displayed. Based on the display of the adjustment cancellation prompt information, a display position of the first adjustment control in the display element level adjustment region before a dragging operation is performed is continuously maintained, and a display status of the first virtual element in the element region before the dragging operation is performed is also continuously included.

In the foregoing process, adjustment of the adjustment control may be automatically triggered to be canceled based on the control adjustment cancellation condition such as the slide distance, so that the user operation process has fault tolerance, to avoid an impact of a slide operation caused by a false touch on levels of the adjustment controls, thereby helping the user to change an adjustment type in time. Clearer feedback information is also provided by using the adjustment cancellation prompt information, to facilitate stability of an element layout, improve operation experience of the user, enhance flexibility and maintainability of terminal display, and improve the efficiency of human-computer interaction.

In some embodiments, if the slide operation corresponds to only the first slide vector component in the first direction, adjustment of the control in the element level adjustment region may also be implemented.

In some embodiments, the adjustment controls include a component adjustment control and a group adjustment control, where a nested relationship exists between the group adjustment control and the component adjustment control, and the component adjustment control and the group adjustment control respectively correspond to control representation features.

The group adjustment control includes at least one component adjustment control, and a group adjustment control at a higher level may alternatively include a group adjustment control at a lower level.

For example, the element level adjustment region includes the following adjustment controls arranged in descending order of levels: a first group adjustment control A, a second group adjustment control B, and a component adjustment control C.

The component adjustment control C belongs to the second group adjustment control B, and the second group adjustment control B belongs to the first group adjustment control A.

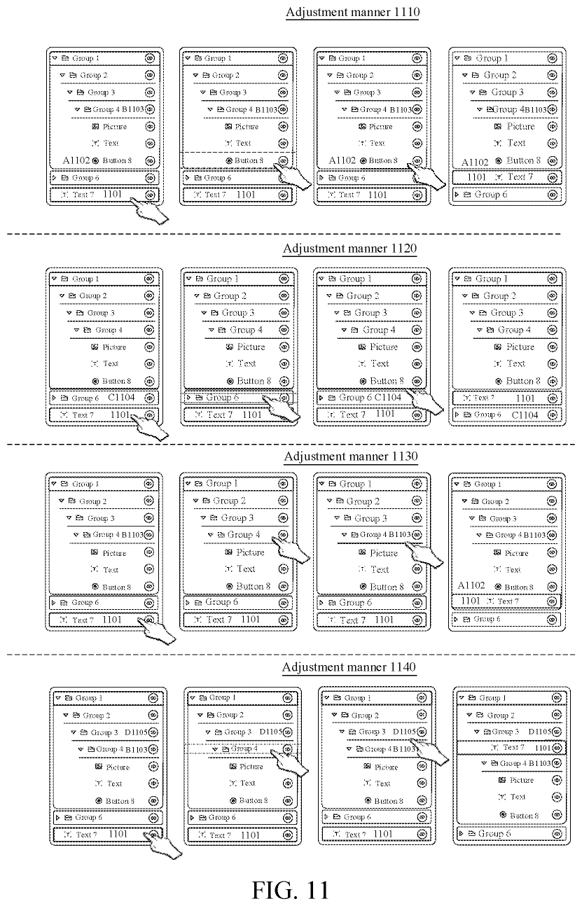

For example, FIG. 11 is a schematic diagram of a manner of adjusting a level of an adjustment control based on a first slide vector component.

In some embodiments, an example in which a representation feature of an adjustment control is a dividing line feature is used for description below. A length of the dividing line feature is configured for indicating a level to which each adjustment control belongs, and a display position of the dividing line feature is configured for indicating the adjustment control to which the dividing line feature belongs.

Adjustment manner 1110: A first adjustment control 1101 is selected and slid in the first direction, a representation feature corresponding to a component adjustment control A1102 is displayed, it is determined that a selected position is located below the component adjustment control A1102, and after releasing, the first adjustment control 1101 and the component adjustment control A1102 are adjacent and belong to the same level. Because the component adjustment control A1102 belongs to a group adjustment control B1103, the adjusted first adjustment control 1101 also belongs to the group adjustment control B1103.

Adjustment manner 1120: The first adjustment control 1101 is selected and slid in the first direction, a representation feature corresponding to a component adjustment control C1104 is displayed, it is determined that a selected position is located directly above the component adjustment control C1104, and after releasing, the first adjustment control 1101 and the component adjustment control C1104 are adjacent and belong to the same level. Because the component adjustment control C1104 does not belong to any group adjustment control, the adjusted first adjustment control 1101 does not belong to any group adjustment control.

Adjustment manner 1130: the first adjustment control 1101 is selected and slid in the first direction, a representation feature corresponding to a group adjustment control B1103 is displayed, it is determined that a selected position is located directly below the group adjustment control B1103, and the first adjustment control 1101 and the group adjustment control B1103 are adjacent and belong to the same level. Because the group adjustment control B1103 includes at least two component adjustment controls (where the lowest is the component adjustment control A1102) and the component adjustment controls are expanded, when the group adjustment control B1103 expands the component adjustment controls, the first adjustment control 1101 is adjacent to the component adjustment control A1102 and belongs to the same level as the group adjustment control B1103.

Adjustment manner 1140: The first adjustment control 1101 is selected and slid in the first direction, the representation feature corresponding to the group adjustment control B1103 is displayed, it is determined that a selected position is located directly above the group adjustment control B1103, and the first adjustment control 1101 and the group adjustment control B1103 are adjacent and belong to the same level. Because the group adjustment control B1103 belongs to a group adjustment control D1105, the adjusted first adjustment control 1101 also belongs to the group adjustment control D1105.

In some embodiments, after the user names an adjustment control, names of adjustment controls belonging to the same level are aligned. A level relationship between different adjustment controls can be intuitively presented, helping the user understand an arrangement between at least two controls, and improving efficiency during control adjustment.

In some embodiments, when level adjustment is performed on the first adjustment control, the first adjustment control may be inserted in the group adjustment control. When the group adjustment control includes another adjustment control, and the group adjustment control expands the another adjustment control or collapses the another adjustment control, a position of the first adjustment control in the group adjustment control is the same. The position of the first adjustment control in the group adjustment control may be arbitrary.

For example, FIG. 12 is a schematic diagram of expanding a component adjustment control by a group adjustment control.

A group adjustment control A1212 expands and arranges an included component adjustment control B1201, component adjustment control C1202, and component adjustment control D1203 from top to bottom in a preset sequence. A first adjustment control 1200 is inserted in the group adjustment control A1212 (for example, is inserted in any position of at least one adjustment control subordinate to the group adjustment control A1212). The first adjustment control 1200 is adjacent to the component adjustment control B1201, is located directly above the component adjustment control B1201, and belongs to the same level as the component adjustment control B1201, the component adjustment control C1202, and the component adjustment control D1203.

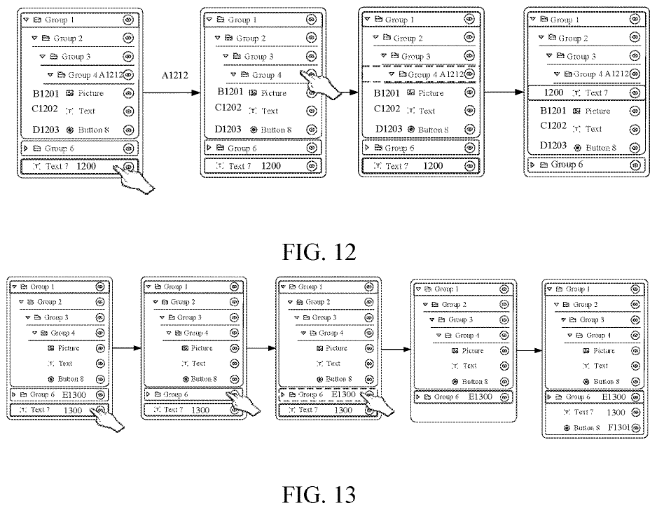

For example, FIG. 13 is a schematic diagram of collapsing a component adjustment control by a group adjustment control.

A group adjustment control E1300 collapses an included adjustment control F1301. A first adjustment control 1300 is inserted in the group adjustment control E1300. In this case, the group adjustment control E1300 also collapses the first adjustment control 1300. After adjustment is completed, the group adjustment control E1300 is expanded. The first adjustment control 1300 is located directly above the component adjustment control F1301, and belongs to the same level as the component adjustment control F1301.

Before receiving the slide operation of the user, the terminal performs region division on each adjustment control in the element level adjustment region. After the slide operation is received, if when the first slide vector component indicates the slide operation, the first adjustment control is inserted in a position adjacent to the adjustment control (including a component adjustment control and a group adjustment control), after the insertion, the first adjustment control and the control belong to the same level; or if when the first slide vector component indicates the slide operation, the first adjustment control is inserted in the group adjustment control, after the insertion, the first adjustment control belongs to the group adjustment control, where a level of the group adjustment control is higher than the first adjustment control.

A region is divided, so that a slide vector component can be calculated in time after the slide operation is received, to determine an adjustment type that a user expects for an adjustment control, thereby improving the efficiency of human-computer interaction. Pictures corresponding to different adjustment types are correspondingly displayed in a slide process, helping the user to learn a control adjustment result.

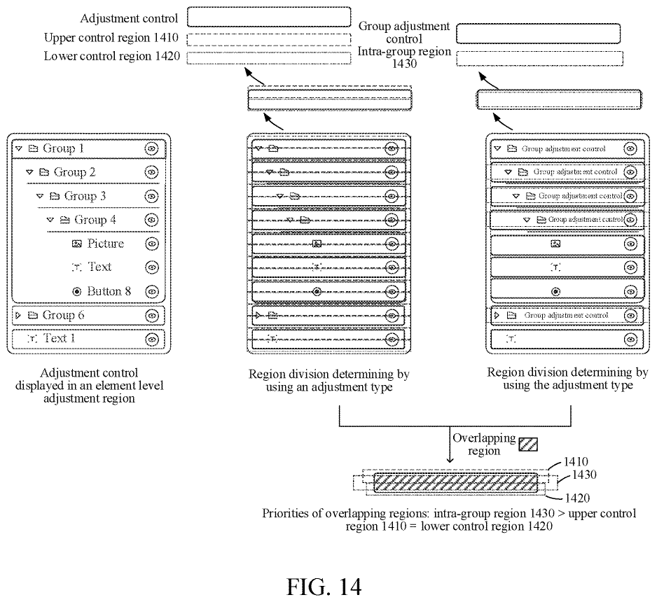

For example, FIG. 14 is a schematic diagram of a process in which a terminal determines a control adjustment type.

Each adjustment control (including a component adjustment control and a group adjustment control) in the element level adjustment region corresponds to an upper control region 1410 and a lower control region 1420 of the adjustment control. The group adjustment control further corresponds to an intra-group region 1430.

When the slide operation performed on the first adjustment control indicates that the selected position is in the upper control region 1410 of an adjustment control A, after the user releases the first adjustment control, the terminal determines to insert the first adjustment control at an adjacent position above the adjustment control A. The first adjustment control has the same level as the adjustment control A.

When the slide operation performed on the first adjustment control indicates that the selected position is in the lower control region 1420 of an adjustment control A, after the user releases the first adjustment control, the terminal determines to insert the first adjustment control at an adjacent position below the adjustment control A. The first adjustment control has the same level as the adjustment control A.

When the slide operation performed on the first adjustment control indicates that the selected position is in the intra-group region 1430 of a group adjustment control B, and after the user releases the first adjustment control, the terminal determines to insert the first adjustment control in the group adjustment control B. The first adjustment control belongs to the group adjustment control B, and a level of the group adjustment control B is higher than the level of the first adjustment control.

For the group adjustment control, an overlapping region exists between the intra-group region 1430 and the upper control region 1410 and between the intra-group region 1430 and the lower control region 1420. When the slide operation indicates that the selected position is located in the overlapping region, it indicates that the adjustment type of the slide operation satisfies two adjustment types (that is, directly insertion at an adjacent position and insertion in the group adjustment control). Priorities of the overlapping regions are as follows: the intra-group region 1430>the upper control region 1410=the lower control region 1420.

That is, insertion of the first adjustment control in the group adjustment control corresponding to the overlapping region is preferentially performed, and the terminal displays a picture of the first adjustment control being inserted in the group adjustment control.

An adjustment type determining manner of choosing to set a priority of the overlapping region can provide more operating space for the user to perform an operation, and determine a control adjustment type expected by the user in time, thereby improving the efficiency of human-computer interaction. Compared with a manner of performing strictly non-overlapping region division on an adjustment control, such a manner can reduce pressure during a user operation, and the user does not need to precisely meet a boundary line to adjust the control, thereby improving efficiency in a control adjustment process.

In conclusion, according to the method provided in the present disclosure, by adjusting the at least two adjustment controls that are arranged in the first direction in the element level adjustment region, the corresponding virtual elements in the display element region can be synchronously adjusted, to adjust the level of the virtual element in the element region. A slide operation performed on the adjustment control is received, and a position of the adjustment control is adjusted based on the slide operation. The slide operation corresponds to a slide vector component separately in the first direction and a second direction, so that the control can be accurately adjusted in at least two directions. When a quantity of adjustment controls in the element level adjustment region is relatively large, it is unnecessary to frequently collapse or expand a control list and then adjust controls. Adjustment is implemented based on slide vector components of a same slide operation in different directions, so that an adjustment process is more convenient, and efficiency of human-computer interaction is improved.

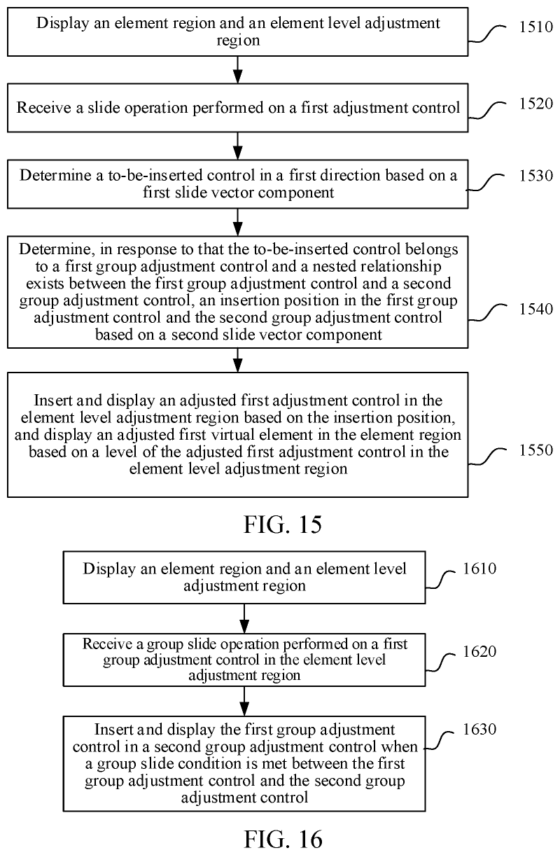

In some embodiments, the adjustment controls include a component adjustment control and a group adjustment control, where a nested relationship exists between the group adjustment control and the component adjustment control, and the component adjustment control and the group adjustment control respectively correspond to control representation features. When the level of the first adjustment control is adjusted based on the slide vector component, it needs to be considered whether a nested relationship exists between the group adjustment control and the selected position at which the first adjustment control is inserted. FIG. 15 is a flowchart of a control adjustment method according to another exemplary embodiment of the present disclosure. The method includes the following operations.

Operation 1510: Display an element region and an element level adjustment region.

The element region includes at least two virtual elements, and the element level adjustment region includes at least two adjustment controls arranged in a first direction. The at least two adjustment controls include a first adjustment control, and the first adjustment control is configured to adjust a first virtual element among the at least two virtual elements.

Operation 1520: Receive a slide operation performed on the first adjustment control.

The slide operation includes a first slide vector component in the first direction and a second slide vector component in a second direction. The first direction and the second direction are different directions.

In some embodiments, the first direction is a vertical axis direction, the second direction is a horizontal axis direction, and the first direction and the second direction are perpendicular to each other.

Operation 1530: Determine a first target control to be inserted in the first direction based on the first slide vector component.

For example, the first target control is an adjustment control determined, based on the first slide vector component, from the at least two adjustment controls included in the control list. In some embodiments, a unique adjustment control is determined, based on the first slide vector component, from the at least two adjustment controls as the first target control to be inserted. For example, the first slide vector component represents a vector component distance of the slide operation in the first direction, the first adjustment control is used as a start point, and an adjustment control at an end point when the first slide vector component ends is used as the first target control.

An adjacent position of the first target control is an insertion position of an adjusted first adjustment control.

For example, the first slide vector component indicates that the first target control is an adjustment control A. If the user releases the first adjustment control (that is, the end point is determined) in this case, the first adjustment control is inserted at an adjacent position of the adjustment control A, to complete level adjustment for the first adjustment control. The first adjustment control after the level adjustment is completed has the same level as the adjustment control A.

Operation 1540: Determine, in response to that the first target control belongs to a first group adjustment control and a nested relationship exists between the first group adjustment control and a second group adjustment control, an insertion position in the first group adjustment control and the second group adjustment control based on the second slide vector component.

The nested relationship is configured for representing a subordination relationship between two group adjustment controls. For example, the first group adjustment control is subordinate to the second group adjustment control.

Based on the second slide vector component in response to that the first target control belongs to the first group adjustment control, and the first group adjustment control belongs to the second group adjustment control, a highlight effect is displayed and switched between the first target control, the first group adjustment control, and the second group adjustment control as control representation features respectively corresponding to the first target control, the first group adjustment control, and the second group adjustment control.

That is, the second group adjustment control (which may be understood as a large group) includes the first group adjustment control (a subgroup), and the first group adjustment control includes the first target control (a control).

The foregoing content describes content of comprehensively switching the highlight effect between the first target control, the first group adjustment control, and the second group adjustment control based on the second slide vector component. This process enables an interface adjustment process to switch display of the highlight effect based on the second slide vector component, greatly enhancing identifiability of the control and intuitiveness of the interface, also enhancing accuracy of a user operation, strengthening a visual association between control levels respectively corresponding to different controls, and helping the user better understand a control level structure, to adapt to more scenarios and wider user requirements.

In some embodiments, a status of the insertion position is determined based on the control representation features of the first target control, the first group adjustment control, and the second group adjustment control. The statuses of the insertion position include, but are not limited to the following several types.
1. When the control representation feature of the first target control is represented as a highlight effect, in response to that the second slide vector component ends, it is determined that the insertion position belongs to the first group adjustment control. The level of the adjusted first adjustment control is the same as a level of the first target control.

For example, an example in which the control representation feature is a dividing line feature is used for description. A length of a dividing line corresponding to the first target control is d, a length of a dividing line corresponding to the first group adjustment control is d+a, and a length of a dividing line corresponding to the second group adjustment control is d+2a, where d and a are positive numbers, and a unit may be arbitrary.

When the second slide vector component is located in an interval length of [d, d+a), the dividing line of the first target control is highlighted, and if the second slide vector component ends in this case, it is determined that the first adjustment control and the first target control belong to the same level. Because the first target control belongs to the first group adjustment control, the adjusted first adjustment control also belongs to the first group adjustment control.
2. When the control representation feature of the first group adjustment control is represented as a highlight effect, in response to that the second slide vector component ends, it is determined that the insertion position belongs to the second group adjustment control. The level of the adjusted first adjustment control is the same as a level of the first group adjustment control.

When the second slide vector component is located in an interval length of [d+a, d+2a), the dividing line of the first group adjustment control is highlighted, and if the second slide vector component ends in this case, it is determined that the first adjustment control and the first group adjustment control belong to the same level. Because the first group adjustment control belongs to the second group adjustment control, the adjusted first adjustment control also belongs to the second group adjustment control.
3. When the control representation feature of the second group adjustment control is represented as a highlight effect, in response to that the second slide vector component ends, it is determined that the insertion position is adjacent to the second group adjustment control. The level of the adjusted first adjustment control is the same as a level of the second group adjustment control.

When the second slide vector component is located in an interval length of [d+2a, d+3a), the dividing line of the second group adjustment control is highlighted, and if the second slide vector component ends in this case, it is determined that the first adjustment control and the second group adjustment control belong to the same level. Because the first group adjustment control does not belong to any group adjustment control, the adjusted first adjustment control does not belong to any group adjustment control.

The foregoing content describes displaying content of different control adjustment results based on the nested relationship between the adjustment controls. In a process of switching to display the highlight effect, if the first target control is presented as the highlight effect, the level of the first target control is used as the level of the adjusted first adjustment control; if the first group adjustment control is presented as the highlight effect, the level of the first group adjustment control is used as the level of the adjusted first adjustment control; and if the second group adjustment control is presented as the highlight effect, the level of the second group adjustment control is used as the level of the adjusted first adjustment control. The foregoing control level adjustment logic implemented based on the highlight effect helps the user control a hierarchy relationship between adjustment controls more intuitively, thereby implementing more flexible dynamic adjustment.

Diversity requirements of the user during creation can be satisfied, so that there is a deeper hierarchical structure between controls, and professional creation tools and experience are provided for the user.

If the second group adjustment control collapses included adjustment controls, the adjusted first adjustment control and the second group adjustment control are adjacent and at the same level. If the second group adjustment control expands the included adjustment controls, the adjusted first adjustment control is adjacent to the lowest adjustment control in the second group adjustment control, and the first adjustment control is at the same level as the second group adjustment control. Alternatively, in some embodiments, the adjusted first adjustment control is adjacent to the second group adjustment control and is located directly above the second group adjustment control. This is not limited in this embodiment.

Considering that when the component adjustment control and the group adjustment control exist in the element level adjustment region, the nested relationship may exist between adjustment controls of different types, when a quantity of the adjustment controls in the element level adjustment region is relatively large, control representation features corresponding to different adjustment controls may be highlighted, to help the user understand a level relationship between different controls based on the control representation features, thereby further improving the efficiency of human-computer interaction.

Operation 1550: Insert and display the adjusted first adjustment control in the element level adjustment region based on the insertion position, and display the adjusted first virtual element in the element region based on the level of the first adjustment control in the element level adjustment region.

For example, in the element level adjustment region, the adjusted first adjustment control is located on a layer below the second adjustment control, the first adjustment control corresponds to the first virtual element in the element region, and the second adjustment control corresponds to a second virtual element in the element region. In this case, that the first virtual element subjected to level adjustment is located on a bottom layer of the second virtual element is displayed in the element region.

In conclusion, the position of the adjustment control is adjusted based on the slide operation. The slide operation corresponds to the slide vector component separately in the first direction and the second direction, so that the control can be accurately adjusted in at least two directions. When a quantity of adjustment controls in the element level adjustment region is relatively large, it is unnecessary to frequently collapse or expand a control list and then adjust controls. Adjustment is implemented based on slide vector components of a same slide operation in different directions, so that an adjustment process is more convenient, and efficiency of human-computer interaction is improved.

According to the method provided in the present disclosure, the first target control is determined by using the first slide vector component determined by the slide operation, so that an interface can respond to a user requirement in time and flexibly, and the insertion position is targetedly determined when an insertion component belongs to the first group adjustment component and a nested relationship exists between two group controls. This helps an existing layout not be significantly adjusted when a control hierarchical structure is accurately understood, and fully ensures accurate adjustment of a control position, thereby improving a dynamic adaptation capability and interaction experience of a user interface. Especially in a complex level and control nesting scenario, misplacement and confusion can be effectively avoided.

The user may combine the adjustment controls in the element level adjustment region, so that the at least two adjustment controls are used as a whole, and for adjustment controls on which a same type of operation needs to be performed for adjustment at the same time, the efficiency of human-computer interaction is improved. After combination, a group adjustment control may be obtained. The group adjustment control may include only the component adjustment control, or grouping may be continued in each group adjustment control, to increase a level depth. In some embodiments, to reduce computing resources consumed during a grouping operation, and avoid a problem that the user cannot quickly locate the first adjustment control due to excessive grouping, a level threshold may be set to constrain a level number of group adjustment controls.

FIG. 16 is a flowchart of a method for performing level adjustment on a group adjustment control according to an exemplary embodiment of the present disclosure. The method includes the following operations.

Operation 1610: Display an element region and an element level adjustment region.

The element region includes at least two virtual elements, and the element level adjustment region includes at least two adjustment controls arranged in a first direction. The at least two adjustment controls include a first adjustment control, and the first adjustment control is configured to adjust a first virtual element among the at least two virtual elements.

The adjustment controls include a component adjustment control and a group adjustment control. A nested relationship exists between the group adjustment control and the component adjustment control, and the component adjustment control includes a first group adjustment control and a second group adjustment control. The first group adjustment control and the second group adjustment control include a component adjustment control.

Operation 1620: Receive a group slide operation performed on the first group adjustment control in the element level adjustment region.

The group slide operation is an operation of sliding in the element level adjustment region and adjusting a level of the first group adjustment control after a user selects the first group adjustment control. The component adjustment control included in the first group adjustment control also implements the level adjustment. Before and after the level adjustment, a level relationship between the first group adjustment control and the component adjustment controls included therein remains unchanged.

For example, a first group adjustment control A does not belong to any group adjustment control (a level is 1), the first group adjustment control A includes a component adjustment control B (a level is 2) and a component adjustment control C (a level is 2), and levels of the component adjustment control B and the component adjustment control C are the same and are both lower than the level of the first group adjustment control A.

A group slide operation is received, so that the first group adjustment control A belongs to a second group adjustment control D (a level is 1), the second group adjustment control D includes a component adjustment control E (a level is 2), and the first group adjustment control A and the component adjustment control E are at the same level and are both lower than the level of the second group adjustment control D (the level of the first group adjustment control A is changed from 1 to 2); and the levels of the component adjustment control B and the component adjustment control C are the same (the levels of the component adjustment control B and the component adjustment control C are changed from 2 to 3) and are both lower than the levels of the first group adjustment control A and the component adjustment control E. Because the first group adjustment control A belongs to the second group adjustment control D, and a nested relationship exists, the levels of the component adjustment control B and the component adjustment control C are also lower than the level of the second group adjustment control D.

Operation 1630: Insert and display the first group adjustment control in the second group adjustment control when a group slide condition is met between the first group adjustment control and the second group adjustment control.

The group slide condition means that a level included in the second group adjustment control is less than or equal to a level threshold after the first group adjustment control is inserted in the second group adjustment control.

In some embodiments, the level threshold is n, that is, each group adjustment control can include at most only n−2 subgroups, where n is an integer greater than 2.

For example, the level threshold is 5, the group adjustment control A is at the highest level of 1, the group adjustment control A includes a group adjustment control B (a level is 2), the group adjustment control B includes a group adjustment control C (a level is 3), the group adjustment control C includes a group adjustment control D (a level is 4), and the group adjustment control D includes a component adjustment control E (a level is 5). Therefore, the group adjustment control D cannot continue to include a subgroup.

For example, a group adjustment control F (a level is 1) exists, and the group adjustment control F includes only a component adjustment control (a level is 2).

Therefore, if the group adjustment control F is inserted in the group adjustment controls A to D, the level numbers of the group adjustment controls after the insertion are changed as follows.
(1) The group adjustment control A=1+2=3<5, (2) the group adjustment control B=2+2=4<5, (3) the group adjustment control C=3+2=5, and (4) the group adjustment control D=4+2=6>5.

Therefore, the group slide condition is met between the group adjustment control F and the group adjustment control A, the group adjustment control B, and the group adjustment control C, and the group adjustment control F may be inserted in the group adjustment control A, the group adjustment control B, and the group adjustment control C. The group slide condition is not met between the group adjustment control F and the group adjustment control D, and the group adjustment control F cannot be inserted in the group adjustment control D.

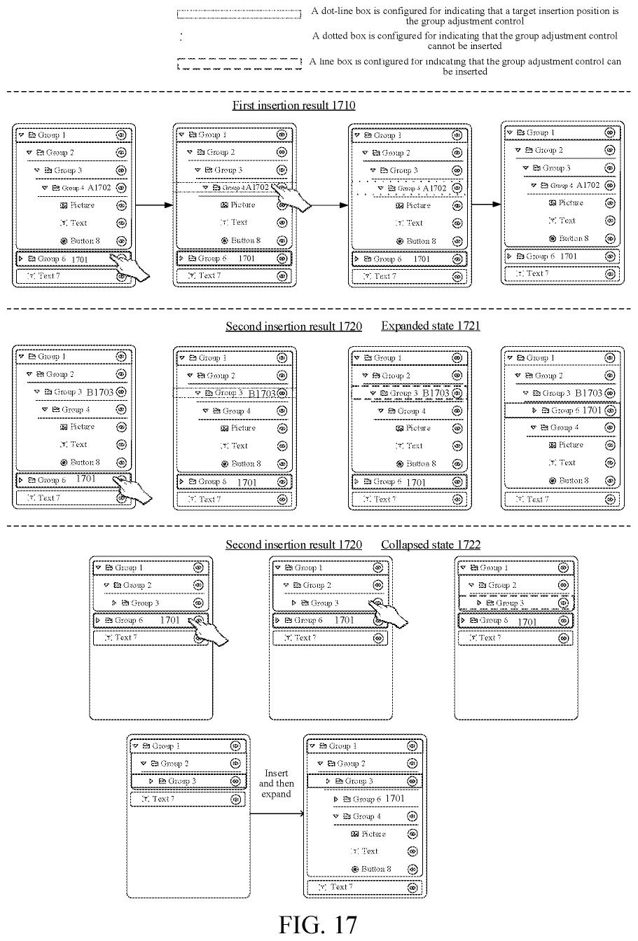

Schematically, FIG. 17 is a schematic diagram of a result of inserting a first group adjustment control in a second group adjustment control. In FIG. 17, an example in which the level threshold is 5 is used for description.

First insertion result 1710: A level of a first group adjustment control 1701 is 1, the first group adjustment control 1701 includes only a component adjustment control (a level is 2), a level of a second group adjustment control A1702 is 4, insertion fails, and the first group adjustment control 1701 and the second group adjustment control A1702 remain displayed.

Second insertion result 1720: The level of the first group adjustment control 1701 is 1, the first group adjustment control 1701 includes only a component adjustment control (a level is 2), a level of a second group adjustment control B1703 is 3, insertion succeeds, and that the first group adjustment control 1701 is inserted in the second group adjustment control B1703 is displayed.

The second insertion result 1720 includes an expanded state 1721 and a collapsed state 1722. In the expanded state 1721, the second group adjustment control B1703 expands adjustment controls included in the second group adjustment control B1703. After the user releases the first group adjustment control 1701, a picture in which the first group adjustment control 1701 is inserted in the second group adjustment control B1703 is directly displayed. The second group adjustment control B1703 in the collapsed state 1722 collapses an adjustment control included therein, and after the user releases the first group adjustment control 1701, the first group adjustment control 1701 is collapsed. The second group adjustment control B1703 may alternatively be triggered to expand, and after the second group adjustment control B1703 expands, that the second group adjustment control B1703 includes the first group adjustment control 1701 is displayed.

In conclusion, the position of the adjustment control is adjusted based on the slide operation. The slide operation corresponds to the slide vector component separately in the first direction and the second direction, so that the control can be accurately adjusted in at least two directions. When a quantity of adjustment controls in the element level adjustment region is relatively large, it is unnecessary to frequently collapse or expand a control list and then adjust controls. Adjustment is implemented based on slide vector components of a same slide operation in different directions, so that an adjustment process is more convenient, and efficiency of human-computer interaction is improved.

In this embodiment of the present disclosure, content of combining adjustment controls to efficiently adjust control levels is described. Through combination, the group adjustment control including the component adjustment control is obtained, grouping may be continued in each group adjustment control to increase a level depth, and control level adjustment may be efficiently implemented by adjusting the group adjustment control, thereby improving level adjustment efficiency. More complex level relationship adjustment can be handled, thereby moving controls in batches. In addition, the level threshold may be set to constrain the level numbers of the group adjustment controls, which helps to avoid excessive complexity of levels, interface clutter, or performance degradation, and provides a simple, efficient, and stable manner to adjust the controls and an interface layout, so that users can have a smoother and more intuitive interactive experience during operation.

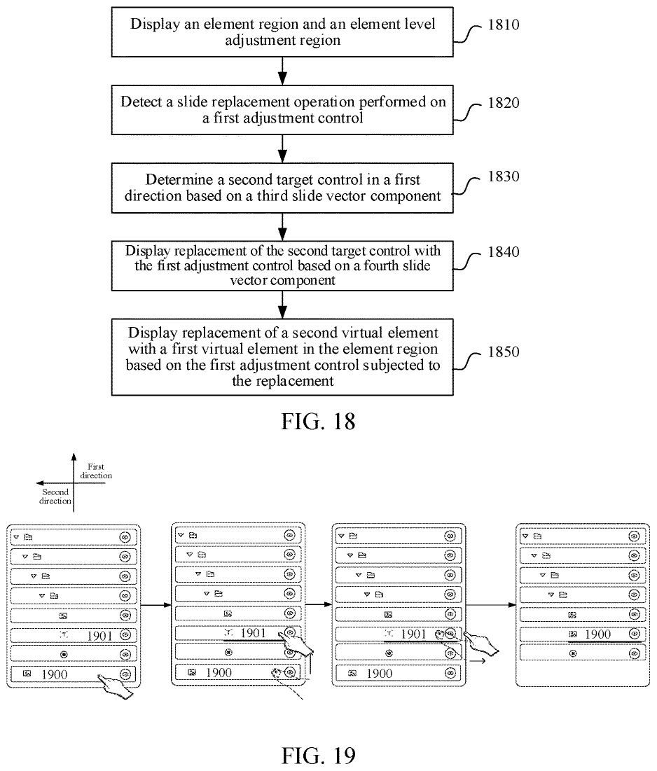

In some embodiments, some adjustment controls exist in the element level adjustment region to be replaced. Alternatively, the user may directly replace the adjustment controls with other adjustment controls by using the slide operation. Compared with a manner of deleting a second target control to be replaced and then inserting a new control, such a manner can improve the efficiency of human-computer interaction. FIG. 18 is a flowchart of a method for replacing an adjustment control by sliding. The method includes the following operations.

Operation 1810: Display an element region and an element level adjustment region.

The element region includes at least two virtual elements, and the element level adjustment region includes at least two adjustment controls arranged in a first direction. The at least two adjustment controls include a first adjustment control, and the first adjustment control is configured to adjust a first virtual element among the at least two virtual elements.

Operation 1820: Receive a slide replacement operation performed on the first adjustment control.

After selecting the first adjustment control, a user slides in the element level adjustment region. The slide replacement operation includes a third slide vector component in the first direction and a fourth slide vector component in a second direction.

In some embodiments, the first direction is a vertical axis direction, the second direction is a horizontal axis direction, and the first direction and the second direction are perpendicular to each other.

Operation 1830: Determine a second target control to be replaced in the first direction based on the third slide vector component.

The second target control corresponds to a second virtual element in the element region.

In some embodiments, each adjustment control in the element level adjustment region separately corresponds to a control representation feature. In a slide process, a terminal displays a change of the control representation feature based on the third slide vector component, and determines a second control representation feature when the third slide vector component ends. An adjustment control having the second control representation feature is determined as the second target control.

Operation 1840: Display replacement of the second target control with the first adjustment control based on the fourth slide vector component.

Display of the second target control in the element level adjustment region is canceled after the replacement, and a level of the first adjustment control after the replacement is the same as a level of the second target control before the replacement.

In some embodiments, the second target control is replaced with the first adjustment control when the fourth slide vector component is not zero.

For example, a level of the first adjustment control before replacement is 1, a level of the second target control before replacement is 2, and a level of the first adjustment control after replacement is 2.

Operation 1850: Display, based on the first adjustment control after the replacement, replacement of the second virtual element with the first virtual element in the element region.

After the replacement, display of the second virtual element corresponding to the second target control in the element region is canceled, and the first virtual element is displayed at a position of the second virtual element before the replacement.

For example, FIG. 19 is a schematic diagram of a process of replacing a control by sliding.

The first adjustment control 1900 is selected and then slid, a control representation feature of the second target control 1901 is displayed based on the third slide vector component in the first direction, replacement is determined based on the fourth slide vector component in the second direction, and after the first adjustment control 1900 is released, the second target control 1901 is replaced with the first adjustment control 1900.

In conclusion, according to the method provided in this embodiment, the adjustment control can be replaced by using only one slide operation. Compared with a manner in which a second target control is first deleted and a first adjustment control is then inserted at an original position of the second target control, the method can improve control adjustment efficiency of the user and efficiency of human-computer interaction.

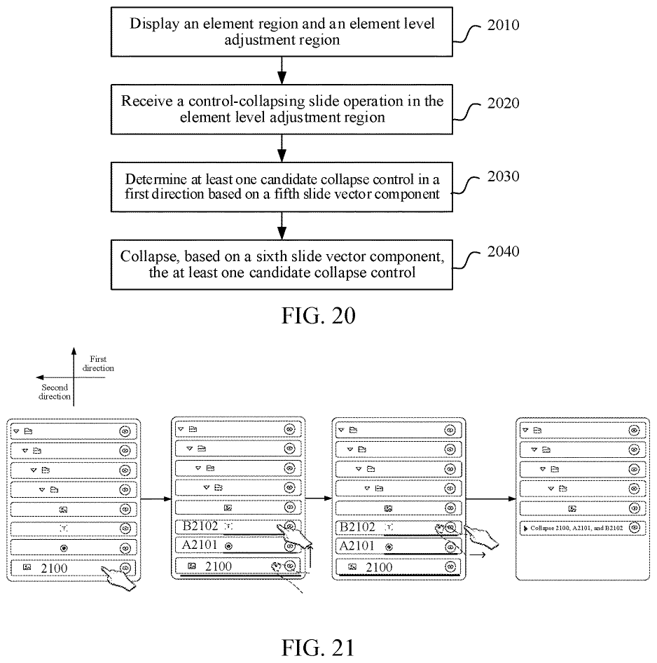

FIG. 20 is a flowchart of a method for collapsing an adjustment control by sliding according to an exemplary embodiment of the present disclosure. The method includes the following operations.

Operation 2010: Display an element region and an element level adjustment region.

The element region includes at least two virtual elements, and the element level adjustment region includes at least two adjustment controls arranged in a first direction. The at least two adjustment controls include a first adjustment control, and the first adjustment control is configured to adjust a first virtual element among the at least two virtual elements.

Operation 2020: Receive a control-collapsing slide operation in the element level adjustment region.

A user slides in the element level adjustment region, determines, based on starting point and end point positions of the slide operation, an adjustment control to be collapsed, and continues to slide and collapse.

Adjustment controls that need to be collapsed are selected by sliding based on user action. Compared with a manner of collapsing all adjustment controls in a single group adjustment control in groups, the selection by sliding manner can implement decoupling between the group adjustment control and the component adjustment control, and reserve an adjustment control that the user needs to present, thereby improving efficiency of adjusting an adjustment control by the user and efficiency of human-computer interaction.

The control-collapsing slide operation includes a fifth slide vector component in the first direction and a sixth slide vector component in the second direction.

Operation 2030: Determine at least one candidate collapse control in the first direction based on the fifth slide vector component.

In some embodiments, a start point of the control-collapsing slide operation may be any adjustment control, and the adjustment control at a start point position may be determined based on a position of a contact point between the user and the terminal, or may be user-defined.

For example, when the user performs a control-collapsing slide operation, the position of the contact point between the user and the terminal is A, and an adjustment control closest to the position A is a start-point adjustment control.

For example, before performing the control-collapsing slide operation, the user selects one of the adjustment controls in the element level adjustment region as the start-point adjustment control.

At least one candidate collapse control is determined based on the fifth slide vector component and the start-point adjustment control.

In some embodiments, each adjustment control in the element level adjustment region separately corresponds to a control representation feature. In a slide process, the terminal highlights, based on the fifth slide vector component, at least one control representation feature respectively corresponding to at least one adjustment control, and determines, when the fifth slide vector component ends, an adjustment control displayed with a control representation feature of highlight as the candidate collapse control.

For example, an example in which the first direction is a vertical direction is used for description. Adjustment controls 1 to 15 are separately arranged from top to bottom in the first direction. The adjustment control 4 is used as the start-point adjustment control. The fifth slide vector component is a slide vector component downward in the first direction. The fifth slide vector component corresponds to widths of five adjustment controls. Therefore, the candidate adjustment controls are: the adjustment control 4, the adjustment control 5, the adjustment control 6, the adjustment control 7, the adjustment control 8, and the adjustment control 9, that is, include the start-point adjustment control and five adjustment controls adjacent to the start-point adjustment control.

Operation 2040: Collapse, based on the sixth slide vector component, the at least one candidate collapse control.

A collapse identifier is correspondingly displayed in the element level adjustment region after the at least one candidate collapse control is collapsed.

In some embodiments, the at least one candidate collapse control is collapsed when the sixth slide vector component is not zero.

Collapsing control by sliding can freely collapse an adjustment control to be collapsed according to a user requirement, thereby providing more solutions as choices when the user collapses or expands a control, and can reserve an adjustment control that the user needs to display, thereby improving efficiency of adjusting the adjustment control by the user and the efficiency of human-computer interaction.

For example, FIG. 21 is a schematic diagram of a process of collapsing an adjustment control by sliding.

After a start-point adjustment control 2100 is selected, control representation features of a start-point adjustment control 2100, a candidate collapse control A2101, and a candidate collapse control B2102 are displayed based on the fifth slide vector component in the first direction. All to-be-collapsed candidate controls are determined based on the fourth slide vector component in the second direction. After the start-point adjustment control 2100 is released, the start-point adjustment control 2100, the candidate collapse control A2101, and the candidate collapse control B2102 are collapsed.

The foregoing process describes content of collapsing a control by using a control-collapsing slide operation to hide the control. This process helps to improve interface neatness. With reference to the fifth slide vector component and the sixth slide vector component, it helps to control a control that needs to be collapsed more flexibly, so that a multi-dimensional slide interaction manner improves intuitiveness and precision of operations. In addition, a displayed collapse identifier enables the user to intuitively view a control collapse status, thereby managing interface elements more conveniently, enhancing feedback and controllability of interaction, reducing complexity of a user operation, and also increasing control management flexibility.

In conclusion, the position of the adjustment control is adjusted based on the slide operation. The slide operation corresponds to the slide vector component separately in the first direction and the second direction, so that the control can be accurately adjusted in at least two directions. When a quantity of adjustment controls in the element level adjustment region is relatively large, it is unnecessary to frequently collapse or expand a control list and then adjust controls. Adjustment is implemented based on slide vector components of a same slide operation in different directions, so that an adjustment process is more convenient, and efficiency of human-computer interaction is improved.

This embodiment of the present disclosure describes content of the slide replacement operation of the adjustment control. The second target control is targetedly determined by using the slide replacement operation, thereby targetedly replacing the second target control with the first adjustment control, which provides an intuitive and easy-to-understand interaction manner. The user may select and replace a control by intuitively sliding, to ensure that a replaced control maintains consistency with an original control at an interface level, which helps avoid overlapping or misplacement of interface elements, improves stability and aesthetics of the user interface, and enhances responsiveness and intuitiveness of the interface.

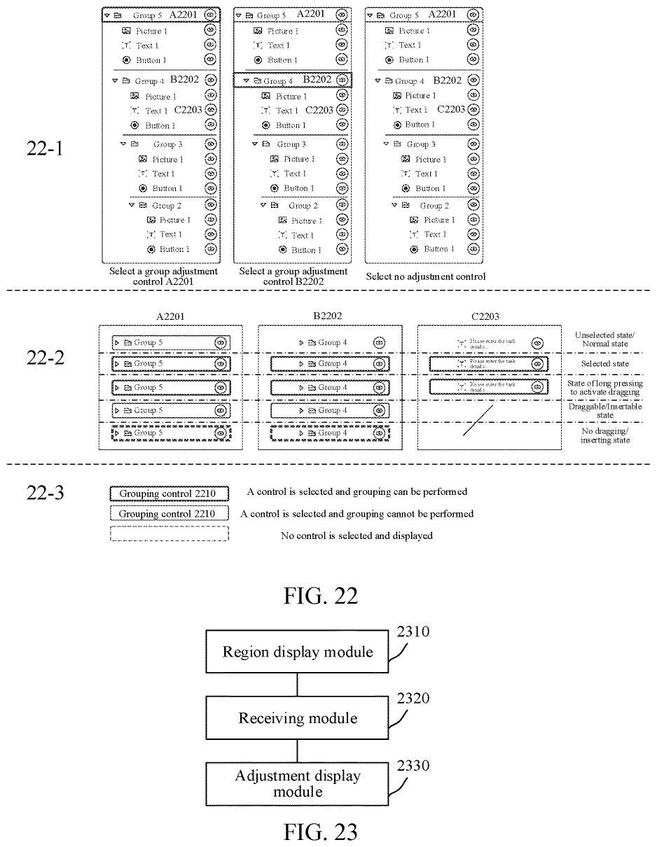

In the foregoing embodiment, when the user performs a corresponding operation on an adjustment control in the element level adjustment region, a selected adjustment control is displayed in a highlighted form and is distinguished from a non-selected adjustment control. For example, FIG. 22 is a schematic diagram of display effects of an adjustment control in different states.

The element level adjustment region includes at least two adjustment controls, for example, a topmost group adjustment control A2201, and a group adjustment control B2202 belonging to the group adjustment control A2201.

As shown in part 22-1, after the group adjustment control A2201 is selected, the group adjustment control A2201 is displayed in a highlighted form. After the group adjustment control B2202 is selected, the group adjustment control B2202 is displayed in a highlighted form.

Part 22-2 shows display effects of different types of adjustment controls in different states, including: (1) a display state in which an adjustment control is not selected; (2) a display state in which an adjustment control is selected; (3) a display state in which an adjustment control is not selected by long-pressing, and the adjustment control may be dragged after the long-pressing; (4) for a group adjustment control, a display state when another adjustment control can be inserted in the group adjustment control; and (5) for a group adjustment control, a display state when another adjustment control cannot be inserted in the group adjustment control.

Types of the adjustment control include the following several types: (1) the group adjustment control A2201: a topmost group in the element level adjustment region; (2) the group adjustment control B2202: a subgroup belonging to the group adjustment control A2201; and (3) a component adjustment control C2203: an adjustment control belonging to the group adjustment control B2202.

In some embodiments, newly creating a subgroup in the group adjustment control, or selecting any quantity of adjustment controls for grouping may be implemented by using a grouping control 2210.

As shown in part 22-3, if no adjustment control is selected, the grouping control 2210 is not displayed.

If an adjustment control is selected from the element level adjustment region, and the adjustment control may be grouped (for example, forming a group with other adjustment controls, continuing to generate a subgroup under the adjustment control, or the like), the grouping control 2210 is highlighted.

In some embodiments, there is a threshold for a level quantity of the group adjustment control. If an adjustment control is selected in the element level adjustment region, and the adjustment control cannot be grouped (for example, the level quantity of the adjustment control has reached the threshold), the grouping control 2210 is displayed and prompt information “No grouping” is displayed.

FIG. 23 is a structural block diagram of a control adjustment apparatus according to an exemplary embodiment of the present disclosure. As shown in FIG. 23, the apparatus includes the following parts:
a region display module 2310, configured to display an element region and an element level adjustment region, the element region including at least two virtual elements, and the element level adjustment region including at least two adjustment controls arranged in a first direction, the at least two adjustment controls including a first adjustment control, and the first adjustment control being configured to adjust a first virtual element among the at least two virtual elements;
a receiving module 2320, configured to receive a slide operation performed on the first adjustment control, the slide operation including a first slide vector component in the first direction and a second slide vector component in a second direction, the first direction being different from the second direction; and
an adjustment display module 2330, configured to display an adjusted first adjustment control based on the first slide vector component and the second slide vector component, and display, based on a level of the adjusted first adjustment control in the element level adjustment region, the first virtual element subjected to level adjustment in the element region.

In an exemplary embodiment, the adjustment display module 2330 is further configured to determine a first control position in the first direction based on the first slide vector component, the first control position corresponding to at least one candidate control; determine a second adjustment control from the at least one candidate control based on the second slide vector component; and display the adjusted first adjustment control based on a control level to which the second adjustment control belongs, a level of the adjusted first adjustment control being the same as the control level to which the second adjustment control belongs.

In an exemplary embodiment, the at least two adjustment controls respectively correspond to control representation features; and
the adjustment display module 2330 is further configured to switch between the at least one candidate control based on the second slide vector component, to display a highlight effect as at least one control representation feature respectively corresponding to the at least one candidate control; and determine, in response to that the second slide vector component ends, a candidate control whose control representation feature is the highlight effect in the at least one candidate control as the second adjustment control.

In an exemplary embodiment, the control representation feature includes a dividing line feature; and
the adjustment display module 2330 is further configured to display a dividing line feature of a selected candidate control based on the second slide vector component, and hide a dividing line feature of an unselected candidate control.

In an exemplary embodiment, the at least two adjustment controls respectively correspond to control representation features; and
the adjustment display module 2330 is further configured to determine a first control level from the at least two control levels based on the second slide vector component, the at least two control levels being sets of levels to which the at least two adjustment controls respectively belong, a subordination relationship existing between the at least two control levels, and at least one adjustment control having the first control level having a first control representation feature; determine, based on the first slide vector component in the first direction, a third adjustment control having the first control representation feature, the third adjustment control having the first control level; and display the adjusted first adjustment control based on the first control level to which the third adjustment control belongs, the level of the adjusted first adjustment control being the first control level corresponding to the third adjustment control.

In an exemplary embodiment, the adjustment controls include a component adjustment control and a group adjustment control, a nested relationship existing between the group adjustment control and the component adjustment control, and the component adjustment control and the group adjustment control respectively corresponding to control representation features; and
the adjustment display module 2330 is further configured to determine a first target control in the first direction based on the first slide vector component; determine, in response to that the first target control belongs to a first group adjustment control and a nested relationship exists between the first group adjustment control and a second group adjustment control, an insertion position in the first group adjustment control and the second group adjustment control based on the second slide vector component; and insert and display the adjusted first adjustment control in the element level adjustment region based on the insertion position.

In an exemplary embodiment, the adjustment display module 2330 is further configured to switch between the first target control, the first group adjustment control, and the second group adjustment control based on the second slide vector component in response to that the first target control belongs to the first group adjustment control, and the first group adjustment control belongs to the second group adjustment control, to display a highlight effect as control representation features respectively corresponding to the first target control, the first group adjustment control, and the second group adjustment control; and when the control representation feature of the first target control is represented as a highlight effect, determine, in response to that the second slide vector component ends, that the insertion position belongs to the first group adjustment control, the level of the adjusted first adjustment control being the same as a level of the first target control.

In an exemplary embodiment, the adjustment display module 2330 is further configured to determine, when the control representation feature of the first group adjustment control is represented as a highlight effect, in response to that the second slide vector component ends, that the insertion position belongs to the second group adjustment control, the level of the adjusted first adjustment control being the same as a level of the first group adjustment control.

In an exemplary embodiment, the adjustment display module 2330 is further configured to determine, when the control representation feature of the second group adjustment control is represented as a highlight effect, in response to that the second slide vector component ends, that the insertion position is adjacent to the second group adjustment control, the level of the adjusted first adjustment control being the same as a level of the second group adjustment control.

In an exemplary embodiment, the adjustment controls include a component adjustment control and a group adjustment control, a nested relationship existing between the group adjustment control and the component adjustment control, and the component adjustment control including a first group adjustment control and a second group adjustment control, the first group adjustment control and the second group adjustment control including a component adjustment control; and
the receiving module 2320 is further configured to receive a group slide operation performed on the first group adjustment control in the element level adjustment region; and insert and display the first group adjustment control in the second group adjustment control when a group slide condition is met between the first group adjustment control and the second group adjustment control, the group slide condition meaning that a level included in the second group adjustment control being less than or equal to a level threshold after the first group adjustment control is inserted in the second group adjustment control.

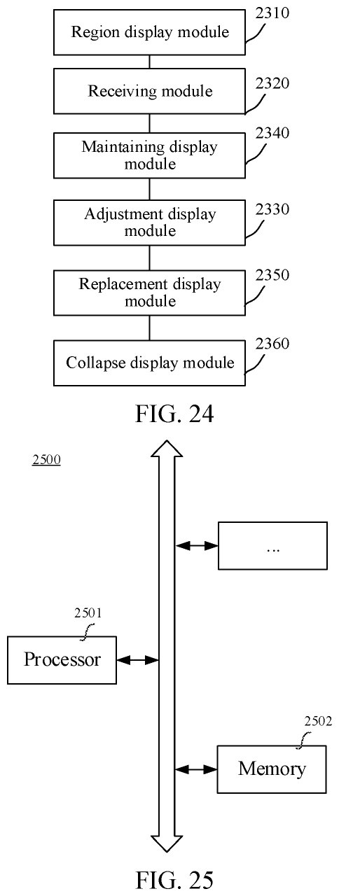

In an exemplary embodiment, after the receiving module 2320, as shown in FIG. 24, the apparatus further includes:
a maintaining display module 2340, configured to cancel, in response to a slide distance corresponding to the slide operation meeting a control adjustment cancellation condition, position adjustment for the first adjustment control in the element level adjustment region, and display adjustment cancellation prompt information; and maintain display of the first adjustment control in the element level adjustment region and the first virtual element in the element region.

In an exemplary embodiment, the apparatus further includes:
a replacement display module 2350, configured to receive a slide replacement operation performed on the first adjustment control, the slide replacement operation including a third slide vector component in the first direction and a fourth slide vector component in the second direction; determine a second target control in the first direction based on the third slide vector component, the second target control corresponding to a second virtual element in the element region; display, based on the fourth slide vector component, replacement of the second target control with the first adjustment control, display of the second target control in the element level adjustment region being canceled after the replacement, and a level of the first adjustment control after the replacement being the same as a level of the second target control before the replacement; and display, based on the first adjustment control after the replacement, replacement of the second virtual element with the first virtual element in the element region.

In an exemplary embodiment, the apparatus further includes:
a collapse display module 2360, configured to receive a control-collapsing slide operation in the element level adjustment region, the control-collapsing slide operation including a fifth slide vector component in the first direction and a sixth slide vector component in the second direction; determine at least one candidate collapse control in the first direction based on the fifth slide vector component; and collapse the at least one candidate collapse control based on the sixth slide vector component, a collapse identifier being correspondingly displayed in the element level adjustment region after the at least one candidate collapse control is collapsed.

In conclusion, according to the apparatus provided in the present disclosure, the position of the adjustment control is adjusted based on the slide operation. The slide operation corresponds to the slide vector component separately in the first direction and the second direction, so that the control can be accurately adjusted in at least two directions. When a quantity of adjustment controls in the element level adjustment region is relatively large, it is unnecessary to frequently collapse or expand a control list and then adjust controls. Adjustment is implemented based on slide vector components of a same slide operation in different directions, so that an adjustment process is more convenient, and efficiency of human-computer interaction is improved.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules.

The control adjustment apparatus provided in the foregoing embodiments is illustrated with an example of division of the foregoing functional modules. In actual application, the functions may be allocated to and completed by different functional modules according to requirements, that is, an internal structure of a device is divided into different functional modules, to implement all or some of the functions described above. In addition, the control adjustment apparatus provided in the foregoing embodiment and the control adjustment method embodiments belong to the same concept, and specific implementation process thereof can be found in the method embodiments. Details are not described herein again.

FIG. 25 is a structural block diagram of a computer device 2500 according to an exemplary embodiment of the present disclosure. The computer device 2500 may be: a smartphone, a tablet computer, a moving picture experts group audio layer III (MP3) player, a moving picture experts group audio layer IV (MP4) player, a laptop computer, or a desktop computer. The computer device 2500 may alternatively be referred to as another name such as user equipment, a portable terminal, a laptop terminal, or a desktop terminal.

Generally, the computer device 2500 includes: a processor 2501 and a memory 2502.

The processor 2501 may include one or more processing cores, such as a 4-core processor and an 8-core processor. The processor 2501 may be implemented by using at least one hardware form of a digital signal processor (DSP), a field-programmable gate array (FPGA), and a programmable logic array (PLA). The processor 2501 may alternatively include a main processor and a coprocessor. The main processor is configured to process data in an activated state, and is also referred to as a central processing unit (CPU). The coprocessor is a low power consumption processor configured to process data in a standby state. In some embodiments, the processor 2501 may have a graphics processing unit (GPU) integrated therein. The GPU is configured to render and draw content that needs to be displayed on a display screen. In some embodiments, the processor 2501 may further include an AI processor. The AI processor is configured to process computing operations related to machine learning.

The memory 2502 may include one or more computer-readable storage media. The one or more computer-readable storage media may be non-transient. The memory 2502 may further include a high-speed random access memory and a non-volatile memory, for example, one or at least two disk storage devices and flash storage devices. In some embodiments, a non-transitory computer-readable storage medium in the memory 2502 is configured to store at least one instruction. The at least one instruction is configured for being executed by the processor 2501, to implement the control adjustment method provided in the method embodiments of the present disclosure.

In some embodiments, the computer device 2500 further includes other components. A person skilled in the art may understand that the structure shown in FIG. 25 constitutes no limitation on the computer device 2500, and may include more or fewer components than those shown in the figure, or some components may be combined, or a different component arrangement may be used.

In some embodiments, the computer-readable storage medium may include: a read-only memory (ROM), a random access memory (RAM), a solid state drive (SSD), an optical disc, or the like. The random access memory may include a resistance random access memory (ReRAM) and a dynamic random access memory (DRAM). The serial numbers of the foregoing embodiments of the present disclosure are merely for description, and do not represent the preference of the embodiments.

An embodiment of the present disclosure further provides a computer device. The computer device includes a processor and a memory, the memory having at least one instruction, at least one program, a code set, or an instruction set stored therein, the at least one instruction, the at least one program, the code set, or the instruction set being loaded and executed by the processor to implement the control adjustment method according to any one of the foregoing embodiments of the present disclosure.

An embodiment of the present disclosure further provides a computer-readable storage medium, having at least one instruction, at least one program, a code set, or an instruction set stored therein, the at least one instruction, the at least one program, the code set, or the instruction set being loaded and executed by a processor to implement the control adjustment method according to any one of the foregoing embodiments of the present disclosure.

An embodiment of the present disclosure further provides a computer program product or a computer program, the computer program product or the computer program including computer instructions, and the computer instructions being stored in a computer-readable storage medium. A processor of a computer device reads the computer instructions from the computer-readable storage medium, and the processor executes the computer instructions, so that the computer device performs the control adjustment method according to any one of the foregoing embodiments.

A person of ordinary skill in the art may understand that all or some of the operations of the foregoing embodiment may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A control adjustment method, performed by a computer device, the method comprising:
displaying an element region comprising at least two virtual elements, and displaying an element level adjustment region comprising at least two adjustment controls arranged in a first direction, the at least two adjustment controls comprising a first adjustment control, and the first adjustment control being configured to adjust a first virtual element among the at least two virtual elements;
detecting a slide operation performed on the first adjustment control, the slide operation comprising a first slide vector component in the first direction and a second slide vector component in a second direction, the first direction being different from the second direction; and
displaying an adjusted first adjustment control based on the first slide vector component and the second slide vector component, and displaying, based on a level of the adjusted first adjustment control in the element level adjustment region, the first virtual element subjected to level adjustment in the element region.

2. The method according to claim 1, wherein the displaying the adjusted first adjustment control based on the first slide vector component and the second slide vector component comprises:
determining a first control position in the first direction based on the first slide vector component, the first control position corresponding to at least one candidate control;
determining a second adjustment control from the at least one candidate control based on the second slide vector component; and
displaying the adjusted first adjustment control based on a level to which the second adjustment control belongs, a level of the adjusted first adjustment control being the same as the level to which the second adjustment control belongs.

3. The method according to claim 1, wherein the at least two adjustment controls respectively correspond to control representation features; and
the determining the second adjustment control from the at least one candidate control based on the second slide vector component comprises:
switching displaying of a highlight effect between the at least one candidate control based on the second slide vector component, to indicate at least one control representation feature respectively corresponding to the at least one candidate control; and
determining, in response to that the second slide vector component ends, a candidate control whose current control representation feature is the highlight effect among the at least one candidate control as the second adjustment control.

4. The method according to claim 1, wherein the control representation feature comprises a dividing line feature; and
the switching between the at least one candidate control based on the second slide vector component, to display a highlight effect as at least one control representation feature respectively corresponding to the at least one candidate control comprises:
displaying a dividing line feature of a selected candidate control based on the second slide vector component, and hiding a dividing line feature of an unselected candidate control.

5. The method according to claim 1, wherein the at least two adjustment controls respectively correspond to control representation features; and
the displaying an adjusted first adjustment control based on the first slide vector component and the second slide vector component comprises:
determining a first control level from at least two control levels based on the second slide vector component, the at least two control levels being sets of levels to which the at least two adjustment controls respectively belong, a subordination relationship existing between the at least two control levels, and at least one adjustment control having the first control level having a first control representation feature;
determining, based on the first slide vector component in the first direction, a third adjustment control having the first control representation feature, the third adjustment control having the first control level; and
displaying the adjusted first adjustment control based on the first control level to which the third adjustment control belongs, the level of the adjusted first adjustment control being the first control level corresponding to the third adjustment control.

6. The method according to claim 1, wherein the adjustment controls comprise a component adjustment control and a group adjustment control, a nested relationship existing between the group adjustment control and the component adjustment control, and the component adjustment control and the group adjustment control respectively corresponding to control representation features; and
the displaying an adjusted first adjustment control based on the first slide vector component and the second slide vector component comprises:
determining a first target control to be inserted in the first direction based on the first slide vector component;
determining, in response to that the first target control belongs to a first group adjustment control and a nested relationship exists between the first group adjustment control and a second group adjustment control, an insertion position in the first group adjustment control and the second group adjustment control based on the second slide vector component; and
inserting and displaying the adjusted first adjustment control in the element level adjustment region based on the insertion position.

7. The method according to claim 1, wherein the determining, in response to that the first target control belongs to a first group adjustment control and a nested relationship exists between the first group adjustment control and a second group adjustment control, an insertion position in the first group adjustment control and the second group adjustment control based on the second slide vector component comprises:
switching between the first target control, the first group adjustment control, and the second group adjustment control based on the second slide vector component in response to that the first target control belongs to the first group adjustment control and the first group adjustment control belongs to the second group adjustment control, to display a highlight effect as control representation features respectively corresponding to the first target control, the first group adjustment control, and the second group adjustment control; and
when the control representation feature of the first target control is represented as a highlight effect, determining, in response to that the second slide vector component ends, that the insertion position belongs to the first group adjustment control, the level of the adjusted first adjustment control being the same as a level of the first target control.

8. The method according to claim 1, further comprising:
when the control representation feature of the first group adjustment control is represented as a highlight effect, determining, in response to that the second slide vector component ends, that the insertion position belongs to the second group adjustment control, the level of the adjusted first adjustment control being the same as a level of the first group adjustment control.

9. The method according to claim 1, further comprising:
when the control representation feature of the second group adjustment control is represented as a highlight effect, determining, in response to that the second slide vector component ends, that the insertion position is adjacent to the second group adjustment control, the level of the adjusted first adjustment control being the same as a level of the second group adjustment control.

10. The method according to claim 1, wherein the adjustment controls comprise a component adjustment control and a group adjustment control, a nested relationship existing between the group adjustment control and the component adjustment control, and the component adjustment control comprising a first group adjustment control and a second group adjustment control, the first group adjustment control and the second group adjustment control comprising a component adjustment control; and
the method further comprises:
receiving a group slide operation performed on the first group adjustment control in the element level adjustment region; and
inserting and displaying the first group adjustment control in the second group adjustment control when a group slide condition is met between the first group adjustment control and the second group adjustment control, the group slide condition meaning that a level comprised in the second group adjustment control being less than or equal to a level threshold after the first group adjustment control is inserted in the second group adjustment control.

11. The method according to claim 1, further comprising:
canceling, in response to a slide distance corresponding to the slide operation meeting a control adjustment cancellation condition, position adjustment for the first adjustment control in the element level adjustment region, and displaying adjustment cancellation prompt information; and
maintaining display of the first adjustment control in the element level adjustment region and the first virtual element in the element region.

12. The method according to claim 1, further comprising:
receiving a slide replacement operation performed on the first adjustment control, the slide replacement operation comprising a third slide vector component in the first direction and a fourth slide vector component in the second direction;
determining a second target control to be replaced in the first direction based on the third slide vector component, the second target control corresponding to a second virtual element in the element region;
displaying, based on the fourth slide vector component, replacement of the second target control with the first adjustment control, display of the second target control in the element level adjustment region being canceled after the replacement, and a level of the first adjustment control after the replacement being the same as a level of the second target control before the replacement; and
displaying, based on the first adjustment control after the replacement, replacement of the second virtual element with the first virtual element in the element region.

13. The method according to claim 1, further comprising:
receiving a control-collapsing slide operation in the element level adjustment region, the control-collapsing slide operation comprising a fifth slide vector component in the first direction and a sixth slide vector component in the second direction;
determining at least one candidate collapse control in the first direction based on the fifth slide vector component; and
collapsing the at least one candidate collapse control based on the sixth slide vector component, a collapse identifier being correspondingly displayed in the element level adjustment region after the at least one candidate collapse control is collapsed.

14. A computer device, comprising a processor and a memory, the memory having at least one program stored therein, and the at least one program being loaded and executed by the processor to implement:.
displaying an element region comprising at least two virtual elements, and displaying an element level adjustment region comprising at least two adjustment controls arranged in a first direction, the at least two adjustment controls comprising a first adjustment control, and the first adjustment control being configured to adjust a first virtual element among the at least two virtual elements;
detecting a slide operation performed on the first adjustment control, the slide operation comprising a first slide vector component in the first direction and a second slide vector component in a second direction, the first direction being different from the second direction; and
displaying an adjusted first adjustment control based on the first slide vector component and the second slide vector component, and displaying, based on a level of the adjusted first adjustment control in the element level adjustment region, the first virtual element subjected to level adjustment in the element region.

15. The device according to claim 14, wherein the displaying the adjusted first adjustment control based on the first slide vector component and the second slide vector component comprises:
determining a first control position in the first direction based on the first slide vector component, the first control position corresponding to at least one candidate control;
determining a second adjustment control from the at least one candidate control based on the second slide vector component; and
displaying the adjusted first adjustment control based on a level to which the second adjustment control belongs, a level of the adjusted first adjustment control being the same as the level to which the second adjustment control belongs.

16. The device according to claim 14, wherein the at least two adjustment controls respectively correspond to control representation features; and
the determining the second adjustment control from the at least one candidate control based on the second slide vector component comprises:
switching displaying of a highlight effect between the at least one candidate control based on the second slide vector component, to indicate at least one control representation feature respectively corresponding to the at least one candidate control; and
determining, in response to that the second slide vector component ends, a candidate control whose current control representation feature is the highlight effect among the at least one candidate control as the second adjustment control.

17. The device according to claim 14, wherein the control representation feature comprises a dividing line feature; and
the switching between the at least one candidate control based on the second slide vector component, to display a highlight effect as at least one control representation feature respectively corresponding to the at least one candidate control comprises:
displaying a dividing line feature of a selected candidate control based on the second slide vector component, and hiding a dividing line feature of an unselected candidate control.

18. The device according to claim 14, wherein the at least two adjustment controls respectively correspond to control representation features; and
the displaying an adjusted first adjustment control based on the first slide vector component and the second slide vector component comprises:
determining a first control level from at least two control levels based on the second slide vector component, the at least two control levels being sets of levels to which the at least two adjustment controls respectively belong, a subordination relationship existing between the at least two control levels, and at least one adjustment control having the first control level having a first control representation feature;
determining, based on the first slide vector component in the first direction, a third adjustment control having the first control representation feature, the third adjustment control having the first control level; and
displaying the adjusted first adjustment control based on the first control level to which the third adjustment control belongs, the level of the adjusted first adjustment control being the first control level corresponding to the third adjustment control.

19. The device according to claim 14, wherein the adjustment controls comprise a component adjustment control and a group adjustment control, a nested relationship existing between the group adjustment control and the component adjustment control, and the component adjustment control and the group adjustment control respectively corresponding to control representation features; and
the displaying an adjusted first adjustment control based on the first slide vector component and the second slide vector component comprises:
determining a first target control to be inserted in the first direction based on the first slide vector component;
determining, in response to that the first target control belongs to a first group adjustment control and a nested relationship exists between the first group adjustment control and a second group adjustment control, an insertion position in the first group adjustment control and the second group adjustment control based on the second slide vector component; and
inserting and displaying the adjusted first adjustment control in the element level adjustment region based on the insertion position.

20. A non-transitory computer-readable storage medium, having at least one program stored therein, the at least one program being loaded and executed by a processor to implement:
displaying an element region comprising at least two virtual elements, and displaying an element level adjustment region comprising at least two adjustment controls arranged in a first direction, the at least two adjustment controls comprising a first adjustment control, and the first adjustment control being configured to adjust a first virtual element among the at least two virtual elements;
detecting a slide operation performed on the first adjustment control, the slide operation comprising a first slide vector component in the first direction and a second slide vector component in a second direction, the first direction being different from the second direction; and
displaying an adjusted first adjustment control based on the first slide vector component and the second slide vector component, and displaying, based on a level of the adjusted first adjustment control in the element level adjustment region, the first virtual element subjected to level adjustment in the element region.
